(19) United States
(12) Patent Application Publication
(10) Pub. No.: US 2023/0377050 A1
(43) Pub. Date: Nov. 23, 2023

(54) INFORMATION PROCESSING SYSTEM, INFORMATION PROCESSING METHOD, INFORMATION TERMINAL, INFORMATION PROCESSING APPARATUS, AND COMPUTER PROGRAM

(71) Applicant: SONY GROUP CORPORATION, TOKYO (JP)

(72) Inventors: TETSUO UMEDA, TOKYO (JP); HAJIME FUKUI, TOKYO (JP)

(21) Appl. No.: 18/246,873

(22) PCT Filed: Aug. 11, 2021
(86) PCT No.: PCT/JP2021/029670

§ 371 Date: Mar. 28, 2023

(30) Foreign Application Priority Data
Oct. 5, 2020 (JP) 2020-168400

(51) Int. Cl. G06Q 40/08

(52) U.S. Cl. CPC G06Q 40/08

(57) ABSTRACT

Provided is an information processing system that determines an insurance premium of an online insurance service. The information processing system includes: an information terminal with which a subscriber performs an insurance subscription procedure; and an information processing apparatus that calculates an insurance premium of insurance of the subscriber. The information terminal acquires first information when the subscriber subscribes to the insurance, acquires second information within a coverage period of the insurance, and transmits the second information to the information processing apparatus. The information processing apparatus calculates a first insurance premium on the basis of the first information, calculates a second insurance premium on the basis of the second information, and determines the insurance premium of the subscriber on the basis of the first insurance premium and the second insurance premium.

### TECHNICAL FIELD

The technology disclosed in the present specification (referred to as “the present disclosure” hereinafter) relates to an information processing system that performs processing of acquiring information to be used to determine an insurance premium and determining the insurance premium on the basis of the acquired information, an information terminal that collects information to be used to determine an insurance premium, an information processing apparatus and an information processing method for performing processing of determining an insurance premium on the basis of information acquired via an information terminal, and a computer program.

### BACKGROUND ART

Recently, online insurance services for performing estimation, selection of an insurance type, and application on the Internet have become widespread. For example, there have been provided online insurance services of life insurance, medical insurance, fire insurance, automobile insurance, and further small-amount insurance for a specific sport or hobby such as golf insurance, mountain insurance, and ski insurance. Furthermore, recently, online insurance services have been also provided for short-term insurance, such as automobile insurance for one day, in which the number of days or the number of times (for example, one round of golf, one climb, skiing for one day, or the like) is limited.

Insurance is a system that compensates a subscriber for damage of the subscriber caused by an event when the event (injuries, damage to equipment, theft, or the like) to which the insurance is applied occurs for the subscriber, and an insurance premium is calculated on the basis of a probability of occurrence of the event and an amount of damage. In the case of insurance services intended for sports and hobbies, it is necessary to prepare for of subscriber's own injuries, theft of articles such as tools and personal items, indemnification for personal injury and property damage, and the like that may occur in sports such as climbing, hiking, skiing, snowboarding, and golf.

In the case of automobile insurance, in order to promote safe driving and reduce accidents, there is known telematics insurance that uses telematics to acquire and analyze driving information for each driver, such as a travel distance and driving characteristics, and calculates an insurance premium on the basis of the information. The telematics is to provide an information service in real time by combining a communication system with a mobile body such as an automobile.

For example, there is proposed an insurance condition determination apparatus including: an acquisition unit that acquires first information regarding a travel route in a case where a user is a driver, and second information regarding a history that the user rides on a vehicle as a fellow passenger other than the driver and a travel route when the user rides as the fellow passenger; and an insurance condition determination unit that determines an insurance condition in accordance with the travel route obtained from the first information acquired by the acquisition unit, the insurance condition determination unit referring to the second information to change the insurance condition to a side advantageous for the user in a case of traveling in an area corresponding to the travel route obtained from the second information (see Patent Document 1).

### CITATION LIST

### Patent Document

Patent Document 1: Japanese Patent Application Laid-Open No. 2017-167963

### SUMMARY OF THE INVENTION

### Problems to be Solved by the Invention

In the case of the insurance services intended for specific sports or hobbies such as golf insurance, mountain insurance, and ski insurance, a probability of occurrence of an event to which insurance is applied varies depending on years of experience and skills of the subscriber himself/herself. However, self-reporting of subscriber's career and skill level may lack objectivity, and there is no determination criterion for evaluating the career and skills in the first place. Therefore, many insurance services of this type have a uniform insurance amount.

An object of the present disclosure is to provide: an information processing system and an information processing method for performing processing of acquiring information to be used to determine an insurance premium in an insurance service mainly intended for a specific sport or hobby and determining the insurance premium on the basis of the acquired information; an information terminal that collects information to be used to determine an insurance premium in an insurance service intended for a specific sport or hobby; an information processing apparatus that performs processing of determining an insurance premium in an insurance service intended for a specific sport or hobby on the basis of information acquired via an information terminal; and a computer program.

### Solutions to Problems

The present disclosure has been made in view of the problems described above, and a first aspect thereof is an information processing system including: an information acquisition unit that acquires first information when a subscriber subscribes to insurance and acquires second information within a coverage period of the insurance; an insurance premium determination unit that calculates a first insurance premium on the basis of the first information, calculates a second insurance premium on the basis of the second information, and determines an insurance premium of the subscriber on the basis of the first insurance premium and the second insurance premium; and a presentation unit that presents information regarding the insurance premium to an information terminal of the subscriber.

However, the term “system” as used herein refers to a logical assembly of a plurality of apparatuses (or functional modules that implement specific functions), and whether or not the respective apparatuses or the respective functional modules are present in a single housing does not matter.

The information processing system according to the first aspect includes, for example, the information terminal with which the subscriber performs an insurance subscription procedure; and an information processing apparatus that calculates the insurance premium of the insurance of the subscriber. The information terminal, as the information acquisition unit, acquires the first information when the subscriber subscribes to the insurance, acquires the second information within the coverage period of the insurance, and transmits the first information and the second information to the information processing apparatus. Furthermore, the information processing apparatus calculates the first insurance premium on the basis of the first information, calculates the second insurance premium on the basis of the second information, and determines a sum of the first insurance premium and the second insurance premium as the insurance premium of the subscriber together with the insurance premium determination unit.

For example, an activity covered by the insurance is climbing, and the coverage period is a day on which the subscriber performs the climbing.

Furthermore, an activity covered by the insurance is golf, and the coverage period is a day on which the subscriber plays the golf.

Furthermore, a second aspect of the present disclosure is an information processing method including: an information acquisition step of acquiring first information when a subscriber subscribes to insurance and acquiring second information within a coverage period of the insurance; an insurance premium determination step of calculating a first insurance premium on the basis of the first information, calculating a second insurance premium on the basis of the second information, and determining an insurance premium of the subscriber on the basis of the first insurance premium and the second insurance premium; and a presentation step of presenting information regarding the insurance premium to an information terminal of the subscriber.

Furthermore, a third aspect of the present disclosure is an information terminal including: an information acquisition unit that acquires first information when a subscriber subscribes to insurance and acquires second information within a coverage period of the insurance; and a presentation unit that presents information regarding an insurance premium of the subscriber determined on the basis of a first insurance premium calculated on the basis of the first information and a second insurance premium calculated on the basis of the second information.

Furthermore, a fourth aspect of the present disclosure is an information processing apparatus including: a reception unit that receives, from an information terminal of a subscriber, first information acquired when the subscriber subscribes to insurance and second information acquired within a coverage period of the insurance; an insurance premium determination unit that calculates a first insurance premium on the basis of the first information, calculates a second insurance premium on the basis of the second information, and determines an insurance premium of the subscriber on the basis of the first insurance premium and the second insurance premium; and a presentation unit that presents information regarding the insurance premium to an information terminal of the subscriber.

Furthermore, a fifth aspect of the present disclosure is a computer program described in a computer-readable format to cause a computer to function as: an information acquisition unit that acquires first information when a subscriber subscribes to insurance and acquires second information within a coverage period of the insurance; an insurance premium determination unit that calculates a first insurance premium on the basis of the first information, calculates a second insurance premium on the basis of the second information, and determines an insurance premium of the subscriber on the basis of the first insurance premium and the second insurance premium; and a presentation unit that presents information regarding the insurance premium to an information terminal of the subscriber.

The computer program according to the fifth aspect of the present disclosure defines the computer program described in the computer-readable format so as to implement predetermined processing on the computer. In other words, cooperative functions are exerted on the computer by installing the computer program according to the fifth aspect of the present disclosure in the computer, and it is possible to obtain functions and effects similar to those of the information processing system according to the first aspect of the present disclosure.

### Effects of the Invention

According to the present disclosure, it is possible to provide the information processing system and the information processing method for performing processing of determining an insurance premium for each subscriber according to a career and a skill level of each subscriber in a short-term insurance service mainly intended for a specific sport or hobby, the information terminal for collecting information to be used to determine the insurance premium for each subscriber according to the career and the skill level of each subscriber in the insurance service intended for the specific sport or hobby, the information processing apparatus for performing the processing of determining the insurance premium for each subscriber according to the career and the skill level of each subscriber in the insurance service intended for the specific sport or hobby on the basis of information acquired via the information terminal, and the computer program.

Note that the effects described in the present specification are merely examples, and effects brought by the present disclosure are not limited thereto. Furthermore, there is also a case where the present disclosure further provides additional effects in addition to the effects described above.

Still other objects, features and advantages of the present disclosure will become apparent from a detailed description on the basis of embodiments as described later and accompanying drawings.

### BRIEF DESCRIPTION OF DRAWINGS

FIG. 1 is a diagram illustrating a configuration example of an information processing system 100.

FIG. 2 is a diagram illustrating a processing sequence example in a case where an online insurance service is implemented on the information processing system 100.

FIG. 3 is a diagram illustrating a configuration example of an information processing apparatus 102.

FIG. 4 is a diagram illustrating a configuration example of an information terminal 101.

FIG. 5 is a diagram illustrating a configuration example of a mountain insurance premium 500.

FIG. 6 is a flowchart illustrating a procedure performed by the information processing system 100 before climbing.

FIG. 7 is a flowchart illustrating a procedure performed by the information processing system 100 during climbing.

FIG. 8 is a view illustrating transitions of insurance premiums of each of members of a climbing party during climbing.

FIG. 9 is a diagram illustrating a functional configuration example for calculating a first insurance premium of the mountain insurance premium.

FIG. 10 is a diagram illustrating a functional configuration example for calculating a second insurance premium of the mountain insurance premium.

FIG. 11 is a view illustrating details of an objective variable, an explanatory variable, and a prediction model in a health state prediction unit 1005.

FIG. 12 is a view illustrating details of an objective variable, an explanatory variable, and a prediction model in a course state prediction unit 1007.

FIG. 13 is a view illustrating types of first information acquired before climbing and input examples of each of the members.

FIG. 14 is a view illustrating types and acquisition examples of second information acquired during climbing, risk assessment examples, and change examples of insurance premiums.

FIG. 15 is a diagram illustrating a golf insurance premium 1500.

FIG. 16 is a flowchart illustrating a procedure performed by the information processing system 100 before golf play.

FIG. 17 is a flowchart illustrating a procedure performed by the information processing system 100 during golf play.

FIG. 18 is a diagram illustrating a functional configuration example for calculating a first insurance premium of the golf insurance premium.

FIG. 19 is a diagram illustrating a functional configuration example for calculating a second insurance premium of the golf insurance premium.

FIG. 20 is a view illustrating types of first information acquired before golf play and input examples of each of the members.

FIG. 21 is a view illustrating types and acquisition examples of second information acquired during golf play, risk assessment examples, and change examples of insurance premiums.

### MODE FOR CARRYING OUT THE INVENTION

Hereinafter, the present disclosure will be described in the following order with reference to the drawings.
A. System Configuration
B. System Operation
C. Apparatus Configuration
D. Application Example to Mountain Insurance
E. Application Example to Golf Insurance

### A. System Configuration

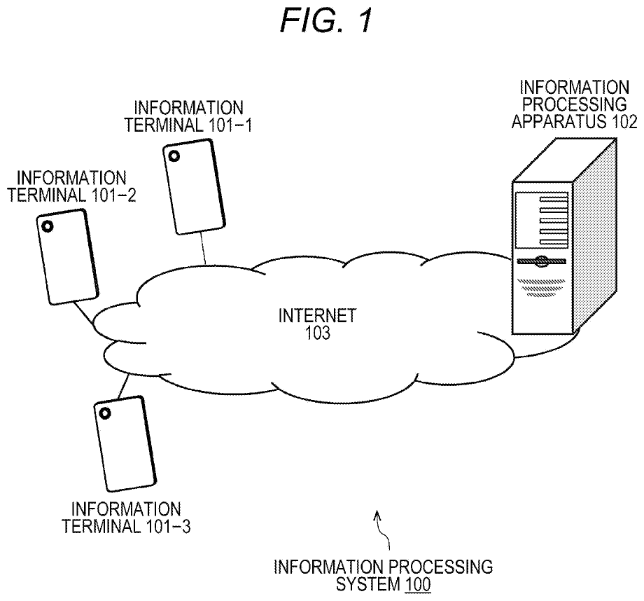

FIG. 1 schematically illustrates a configuration example of an information processing system 100 to which the present disclosure is applied. The illustrated information processing system 100 is configured by interconnecting information terminals 101-1, 101-2, and so on used by each subscriber of an insurance service and an information processing apparatus 102 that executes information processing for determining an insurance premium of each subscriber via a network such as the Internet 103. The information terminals 101-1, 101-2, and so on are multifunctional information terminals such as smartphones and tablets, but may be personal computers. Furthermore, the information processing apparatus 102 may be, for example, a server operated by an insurance company. Note that not only a subscriber who has finally applied for insurance but also a prospective subscriber who has not yet taken a subscription procedure are collectively referred to as subscribers for convenience in the present specification. Furthermore, it is assumed that the prospective subscriber always subscribes to the insurance without cancelling in the middle of the subscription procedure in order to simplify the description.

The information terminals 101-1, 101-2, and so on are used by users for the insurance subscription procedure. That is, on each of the information terminals 101-1, 101-2, and so on, subscriber information for identifying a subscriber such as name, gender, age, occupation, and address of the subscriber, and information necessary for subscribing to the insurance such as selection of a type of the insurance and a condition of the insurance such as a compensation amount are input. The information necessary for subscribing to the insurance includes information used to calculate an insurance premium. Furthermore, information input to the information terminals 101-1, 101-2, and so on includes information based on input operations of the users with respect to input apparatuses such as a touch panel, information obtained by performing speech recognition of input speeches of the users, sensor information from sensors included in the information terminals 101-1, 101-2, and so on or a peripheral Internet of Things (IoT) device, and the like. Then, the information terminals 101-1, 101-2, and so on transfer the input information to the information processing apparatus 102, and perform the insurance subscription procedure.

The information processing apparatus 102 estimates damage of the subscribers when an event to which the insurance is applied (injuries, damage to equipment, theft, or the like) occurs on the basis of the subscriber information acquired from the information terminals 101-1, 101-2, and so on, and calculates the insurance premiums claimed to the respective subscribers from the estimation result. Then, the information processing apparatus 102 transmits the calculated insurance premiums of the subscribers to the corresponding information terminals 101-1, 101-2, and so on.

The insurance premiums received from the information processing apparatus 102 are presented on the respective information terminals 101-1, 101-2, and so on. Furthermore, payment procedures of the presented insurance premiums may be performed at the same time on the information terminals 101-1, 101-2, and so on.

The insurance service handled on the information processing system 100 according to the present disclosure is basically a so-called online insurance service. More specifically, the insurance service handled on the information processing system 100 according to the present disclosure is an online insurance service mainly intended for a sport or a hobby and covering subscriber's own injuries, theft, and indemnification for personal injury and property damage caused by the sport or a hobby such as climbing, hiking, skiing, snowboarding, and golf, and in particular, is a short-term online insurance service in which the number of days or the number of times (for example, one round of golf, one climb, skiing for one day, or the like) is limited.

In a case where the information processing system 100 is applied to an online insurance service intended for a sport or a hobby, the information processing apparatus 102 estimates an amount of damage for the subscriber's own injuries, theft of articles such as tools and personal items, and the indemnification for personal injury and property damage, which occur while the subscriber who is the user of the information terminal 101 is enjoying a sport or a hobby covered by the insurance, on the basis of the information acquired from the information terminal 101, and determines an insurance premium from the estimated amount.

In the case of an insurance service intended for a specific sport or hobby, a probability of occurrence of an event to which insurance is applied varies depending on years of experience and skills of the subscriber himself/herself. Therefore, it is preferable to evaluate a state of an individual including a career and a skill of each of the subscribers to calculate an insurance premium. However, self-reporting of subscriber's career and skill level may lack objectivity, and there is no determination criterion for evaluating the career and skills in the first place. Therefore, in most of conventional short-term insurance services, an insurance amount is set to be uniform regardless of a difference in the career and skill level of each of the subscribers in many cases.

If insurance premiums are set to be uniform for all the subscribers, the insurance premium is too high for a subscriber with abundant experiences and a high skill level although a probability of occurrence of an event to which the insurance is applied is low, and the insurance premium is low for a subscriber who is a beginner or has an insufficient skill level although a probability of occurrence of an event to which the insurance is applied is high, which is unfair. Furthermore, many sports are played in nature, and thus, are easily affected by environments in which competitions actually occur, such as a place and weather, and the probability of occurrence of the event to which the insurance is applied varies depending on the environments of competitions even for subscribers with the same background and skill level. Of course, even for the subscribers with the same background and skill level, the probability of occurrence of the event to which the insurance is applied varies depending on health states of the subscribers on the day of a competition, an environment of the competition, and the like.

On the other hand, in a case where the information processing system 100 according to the present disclosure is applied to, for example, a short-term insurance service such as mountain insurance or golf insurance, an appropriate and fair insurance premium is calculated in consideration of not only information reported by a subscriber at the time of subscribing to the insurance, but also a career and a skill of the subscriber in a sports competition such as climbing or golf, a health state of the subscriber on the day of the competition such as climbing or golf, an environment of the competition, and the like.

That is, in the information processing system 100 according to the present disclosure, when a subscriber performs the insurance subscription procedure using his/her own information terminal 101, the information processing apparatus 102 calculates a first insurance premium on the basis of first information acquired from the information terminal 101, calculates a second insurance premium on the basis of second information acquired through the information terminal 101 or the like of the subscriber while the subscriber is performing activities related to a sport or a hobby to be covered by insurance during a coverage period of the insurance, and sets a total amount of the first insurance premium and the second insurance premium as an insurance premium of the subscriber.

Here, the first information and the second information each include information input on a touch panel and a speech input by the subscriber with respect to the information terminal 101, and sensor information from a sensor in the information terminal 101 or an IoT device around the information terminal 101.

The first information is mainly subscriber information for identifying the subscriber such as the name, gender, age, occupation, and address of the subscriber, selection of a type of the insurance (such as a sports or hobby item covered by the insurance), insurance conditions such as a compensation amount, a health state self-reported by the subscriber, a career and a skill level of the item, and the like. The career and skill level of the subscriber may be information of characters or numbers on the basis of a self-report input on the touch panel by the subscriber, or may be information of a career and a skill level estimated on the basis of an analysis result of the sensor information acquired using the sensor in the information terminal 101 or the IoT device. For example, the skill level of the subscriber estimated from the sensor information by an application that analyzes the sensor information of the sensor in the information terminal 101 or the IoT device may be used as the first information. Furthermore, the first information may include prediction information within the insurance coverage period. For example, the first information may include information regarding a place where the sports or hobby item to be covered by the insurance is implemented, or prediction information regarding weather or other environments. Furthermore, the first information may include prediction information such as information regarding an implementation place or a weather forecast acquired by web access.

Furthermore, the second information is information regarding the subscriber's own health state or information regarding weather or other environments of a place where the sports or hobby item to be covered by the insurance is implemented, the information being acquired using the sensor in the information terminal 101 or the IoT device during the insurance coverage period (for example, during climbing or golf play). For example, state information of the subscriber estimated from the sensor information by an application that analyzes the sensor information of the sensor in the information terminal 101 or the IoT device may be used as the second information. Furthermore, the second information may include information regarding an implementation place or weather information in the insurance coverage period acquired by web access.

The information processing apparatus 102 calculates the first insurance premium on the basis of the first information acquired from the information terminal 101 of the subscriber mainly at the time of the insurance subscription procedure. In the present disclosure, the information processing apparatus 102 estimates a probability of occurrence of an event to be covered by the insurance for a person having attribute information such as gender, age, and occupation of the subscriber acquired from the information terminal 101 at the time of subscribing to the insurance, and calculates a uniform base insurance premium for persons having the same attribute information. Furthermore, in the present disclosure, the information processing apparatus 102 calculates an individual personal insurance premium for each of the subscribers in consideration of a variation in the probability of occurrence of the event to be covered by the insurance according to the health state, career, or skill level of the subscriber included in the first information. Furthermore, the information processing apparatus 102 may calculate the individual personal insurance premium for each of the subscribers in further consideration of information regarding the place where the subscriber implements the sports or hobby item to be covered by the insurance or the prediction information regarding the weather or other environments. Then, the information processing apparatus 102 determines the first insurance premium by adding the individual personal insurance premium for each of the subscribers to the uniform base insurance premium.

Furthermore, the information processing apparatus 102 calculates the second insurance premium on the basis of the second information acquired from the information terminal 101 of the subscriber mainly within the insurance coverage period. In the present disclosure, the information processing apparatus 102 re-estimates a probability of occurrence of the event to be covered by the insurance on the basis of the information regarding the subscriber's own health state acquired from the information terminal 101 during the insurance coverage period and the information regarding the weather or other environments of the place where the sports or hobby item to be covered by the insurance is implemented, and calculates changes of the base insurance premium and the personal insurance premium according to the health state of the subscriber or the implementation environment. Then, the information processing apparatus 102 adds the change of the base insurance premium and the change of the personal insurance premium calculated as the second insurance premium to the base insurance premium and the personal insurance premium calculated as the first insurance premium, and determines a final insurance premium of the subscriber.

The information processing apparatus 102 transmits the finally determined insurance premium to the information terminal 101 of the corresponding subscriber. The information terminal 101 side presents the received insurance premium to the subscriber using, for example, a display. The subscriber may perform a payment procedure directly on a screen of the information terminal 101 presenting the insurance premium.

### B. System Operation

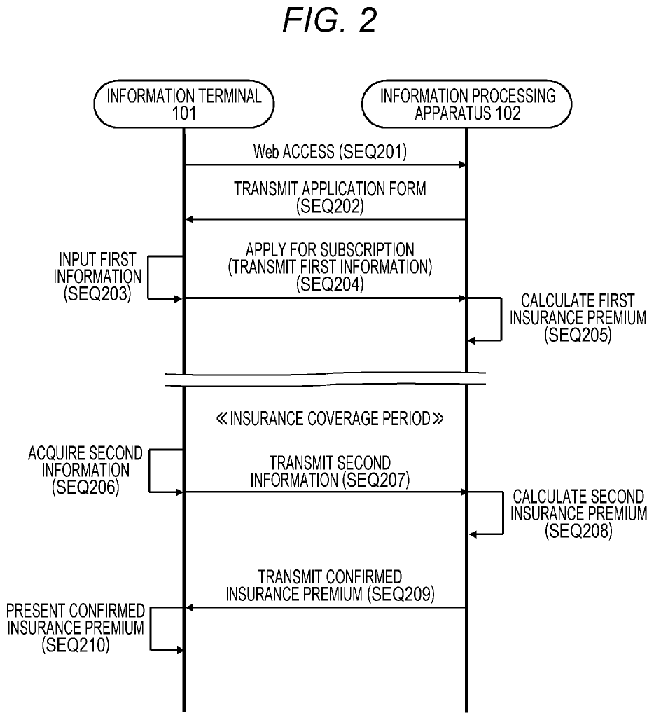

FIG. 2 illustrates a processing sequence example in a case where an online insurance service is implemented on the information processing system 100. As the online insurance service, a short-term insurance service intended for a specific sport or hobby is assumed.

A subscriber accesses an online insurance service site operated by the information processing apparatus 102 using his/her information terminal 101 (SEQ201). In response, the information processing apparatus 102 returns a form for applying for subscription to the online insurance service to the information terminal 101 (SEQ202).

The information terminal 101 side displays the received form on a screen, and the subscriber inputs first information (SEQ203). The first information includes subscriber information for identifying the subscriber such as name, gender, age, occupation, and address of the subscriber, and information such as the type of the selected insurance and the condition of the insurance. Moreover, the subscriber also inputs a career or a skill level of a sport or a hobby to which insurance is applied into the form using the information terminal 101.

Regarding the career or skill level of the subscriber, the subscriber may use a touch panel to input information regarding his/her years of experience and characters or numbers indicating his/her skill level, such as “high”, “intermediate”, and “low”. Furthermore, information obtained by estimating the career or skill level on the basis of a result of analyzing sensor information obtained by capturing an action or the like of the subscriber using a sensor in the information terminal 101 or a peripheral IoT device may be used.

Furthermore, the first information may include prediction information within a coverage period of short-term insurance. For example, the first information may include information regarding a place where the sports or hobby item to be covered by the insurance is implemented, or prediction information regarding weather or other environments. The prediction information may be manually input into the form by the subscriber himself/herself or may be automatically input into the form by the information terminal 101 accessing the Web such as a weather forecast site and acquiring the prediction information.

When filling of the application form is completed, the information terminal 101 returns the application form to the information processing apparatus 102 and applies for subscription to the insurance service (SEQ204). Therefore, the information processing apparatus 102 can acquire the first information of the subscriber from the information terminal 101 in a mode of receiving the application form.

The information processing apparatus 102 calculates a first insurance premium on the basis of the first information acquired from the information terminal 101 of the subscriber mainly at the time of an insurance subscription procedure (SEQ205). The information processing apparatus 102 estimates a probability of occurrence of an event to be covered by the insurance for a person having attribute information such as gender, age, and occupation of the subscriber acquired from the information terminal 101 at the time of subscribing to the insurance, and calculates a uniform base insurance premium for persons having the same attribute information. Furthermore, in the present disclosure, the information processing apparatus 102 calculates an individual personal insurance premium for each of the subscribers in consideration of a variation in the probability of occurrence of the event to be covered by the insurance according to the health state, career, or skill level of the subscriber included in the first information. Furthermore, the information processing apparatus 102 may calculate the individual personal insurance premium for each of the subscribers in further consideration of information regarding the place where the subscriber implements the sports or hobby item to be covered by the insurance or the prediction information regarding the weather or other environments. Then, the information processing apparatus 102 determines the first insurance premium by adding the individual personal insurance premium for each of the subscribers to the uniform base insurance premium.

Thereafter, the coverage period of the insurance to which the subscriber has subscribed begins. The insurance coverage period corresponds to, for example, a period of climbing under a mountain insurance or play under a golf insurance.

The information terminal 101 acquires second information during the insurance coverage period (SEQ206) and transmits the second information to the information processing apparatus 102 (SEQ207). Although the acquisition of the second information and the transmission to the information processing apparatus 102 are illustrated only once in FIG. 2 in order to simplify the drawing, the information terminal 101 may acquire the second information and transmit the second information to the information processing apparatus 102 a plurality of times periodically or at arbitrary timings within the insurance coverage period.

The information terminal 101 uses the sensor in the information terminal 101 or the IoT device to acquire the second information including information regarding the subscriber's own health state and information regarding weather or other environments of a place where the sports or the hobby item to be covered by the insurance is implemented. For example, state information of the subscriber estimated from the sensor information by an application that analyzes the sensor information of the sensor in the information terminal 101 or the IoT device may be used as the second information. Furthermore, the second information may include information regarding an implementation place or weather information in the insurance coverage period acquired by web access.

The information processing apparatus 102 calculates a second insurance premium on the basis of the second information acquired from the information terminal 101 of the subscriber within the insurance coverage period (SEQ208). That is, the information processing apparatus 102 re-estimates a probability of occurrence of the event to be covered by the insurance on the basis of the information regarding the subscriber's own health state acquired from the information terminal 101 during the insurance coverage period and the information regarding the weather or other environments of the place where the sports or hobby item to be covered by the insurance is implemented, and calculates changes of the base insurance premium and the personal insurance premium according to the health state of the subscriber or the implementation environment. Then, the information processing apparatus 102 adds the change of the base insurance premium and the change of the personal insurance premium calculated as the second insurance premium to the base insurance premium and the personal insurance premium calculated as the first insurance premium, and determines a final insurance premium of the subscriber.

After the insurance coverage period has elapsed, the information processing apparatus 102 transmits the finally confirmed insurance premium to the information terminal 101 of the corresponding subscriber (SEQ209).

The information terminal 101 side presents the finally confirmed insurance premium received from the information processing apparatus 102 to the subscriber using, for example, a display (SEQ210). The subscriber may perform a payment procedure directly on a screen of the information terminal 101 presenting the insurance premium.

Note that the insurance premium determination processing performed by the information processing apparatus 102 in the processing sequence example illustrated in FIG. 2 can also be executed by an insurance application executed on the information terminal 101. In this case, all the processing sequences illustrated in FIG. 2 are performed in the information terminal 101.

### C. Apparatus Configuration

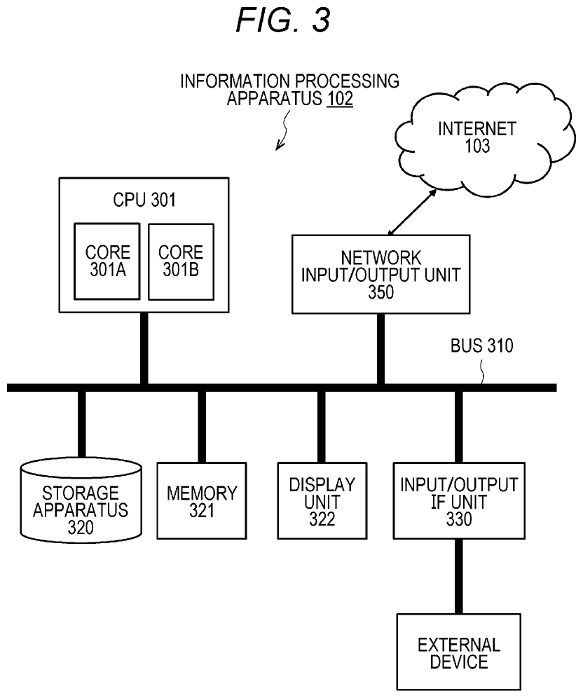

FIG. 3 illustrates a configuration example of the information processing apparatus 102. The information processing apparatus 102 is, for example, a server apparatus installed on the Internet 103.

The information processing apparatus 102 operates under the overall control of a central processing unit (CPU) 301. In the illustrated example, the CPU 301 has a multi-core configuration including a processor core 301A and a processor core 301B. The CPU 301 is interconnected with each component in the information processing apparatus 102 via a bus 310.

A storage apparatus 320 includes, for example, a large-capacity external storage apparatus, such as a hard disk drive (HDD) or a solid state drive (SSD), and stores files such as programs executed by the CPU 301 and data generated by using the programs during execution or by executing the programs. The CPU 301 executes, for example, a program for transmitting an insurance subscription application form to the information terminal 101, a processing program of the application form returned from the information terminal 101, a processing program for calculating a first insurance premium on the basis of first information acquired from the information terminal 101, a processing program for calculating a second insurance premium on the basis of second information acquired from the information terminal 101, a processing program for presenting a total of the first insurance premium and the second insurance premium to the information terminal 101 to perform an insurance subscription procedure, and the like.

Note that the processing of calculating the first insurance premium on the basis of the first information may use a learning model that has been subjected to deep learning so as to calculate the first insurance premium by predicting a probability of occurrence of an event to be covered by insurance for a subscriber from the first information. Furthermore, the processing of calculating the second insurance premium on the basis of the second information may use a learning model that has been subjected to deep learning so as to calculate the second insurance premium by predicting a probability of occurrence of the event to be covered by the insurance for the subscriber within an insurance coverage period from the second information. The storage apparatus 320 may accumulate model information of these deep-learned learning models. Furthermore, the processor core 301A or 301B of the CPU 301 may calculate the first insurance premium and the second insurance premium by the deep-learned learning models on the basis of the model information read from the storage apparatus 320.

Furthermore, the storage apparatus 320 accumulates health information, insurance subscription history information, and other personal information of each of subscribers of an insurance service.

A memory 321 includes a read only memory (ROM) and a random access memory (RAM). The ROM stores, for example, a startup program and basic input/output programs of the information processing apparatus 102. The RAM is used for loading a program to be executed by the CPU 301 and temporarily storing data to be used during execution of the program.

A display unit 322 includes, for example, a liquid crystal display or an organic electro luminescence (EL) display. The display unit 322 displays data and an execution result during execution of a program by the CPU 301. For example, the completed application form received from the information terminal 101, the first insurance premium calculated on the basis of the first information acquired from the information terminal 101, the second insurance premium calculated on the basis of the second information acquired from the information terminal 101 within the insurance coverage period, a final insurance premium obtained by adding the first insurance premium and the second insurance premium, a confirmation screen of the insurance subscription procedure via the information terminal 101, and the like are displayed on the display unit 322.

An input/output interface unit 330 transmits and receives data to and from an external device. The external device is, for example, an input apparatus such as a keyboard or a mouse, or an output apparatus such as a speaker.

a network input/output unit 350 performs input/output processing between the information processing apparatus 102 and the Internet 103. In the present embodiment, the network input/output unit 350 performs processing such as transmission of the subscription application form, reception of the completed subscription application form, transmission of the final insurance premium, and transmission and reception of information for the insurance subscription procedure with each of the information terminals 101-1, 101-2, 101-3, and so on.

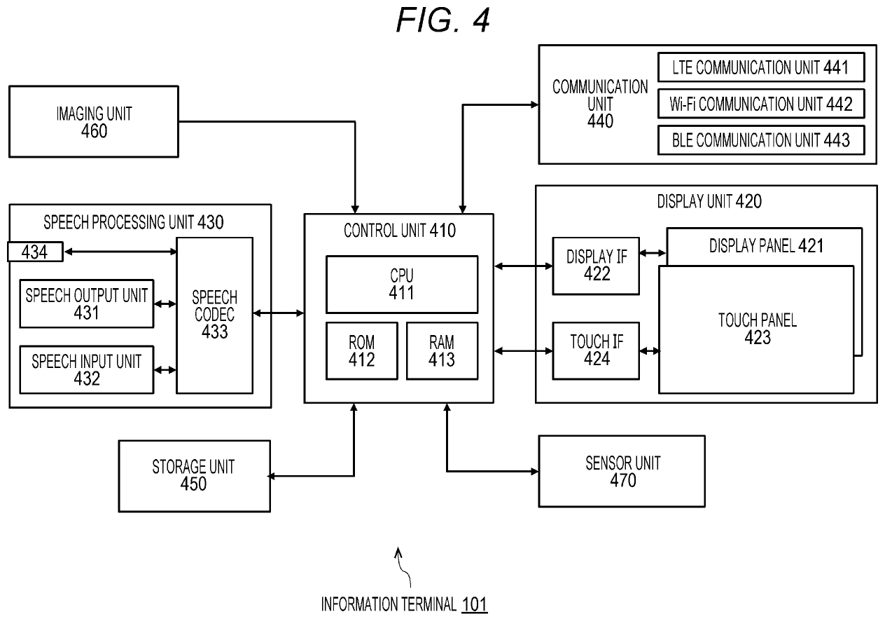

FIG. 4 illustrates a configuration example of the information terminal 101. The information terminal 101 is a multifunctional information terminal such as a smartphone or a tablet used by an insurance subscriber, and is configured by connecting a display unit 420, a speech processing unit 430, a communication unit 440, a storage unit 450, an imaging unit 460, a sensor unit 470, and the like to a control unit 410.

The control unit 410 includes a CPU 411, a ROM 412, a RAM 413, and the like. The ROM 412 stores a program to be executed by the CPU 411, information necessary for the information terminal 102, and the like. The CPU 411 may have a multi-core configuration.

The CPU 411 loads a program and code from the ROM 412 or the storage unit 450 into the RAM 413 and executes the program and code. Examples of the program executed by the CPU 411 include an operating system (OS) such as Android or iOS, and various application programs that operate under an execution environment provided by the OS. The application programs referred to herein are so-called smartphone applications. For example, the smartphone applications include a phone, a camera, a mail, a schedule, a communication application for communicating with an external apparatus such as the information processing apparatus 102, a web application for accessing the Web, and the like.

Furthermore, the CPU 411 may execute an “insurance application (provisional name)” for performing the insurance subscription procedure with respect to the information processing apparatus 102 in the present embodiment. The insurance application accesses the information processing apparatus 102 to display the insurance subscription application form, generates the first information and the second information on the basis of sensor information acquired from the sensor unit 470 in the information terminal 101 or an IoT device, information acquired through the web application, and the like, transmitting the subscription application form in which the first information incorporated to the information processing apparatus 102, transmits the second information to the information processing apparatus 102 during the insurance coverage period, and executes presentation of the final insurance premium received from the information processing apparatus 102, a payment procedure of the insurance premium, and the like. Note that an insurance application executed on the information terminal 101, instead of the information processing apparatus 102, may also perform insurance premium calculation processing.

The display unit 420 includes a display panel 121 including a liquid crystal element, an organic EL element, or the like, and a transparent touch panel 423 bonded to an upper surface of the display panel 421. The display panel 421 is connected to the control unit 410 via a display interface 422, and displays and outputs image information generated by the control unit 410. Furthermore, the touch panel 423 is connected to the control unit 410 via the touch interface 424, and outputs coordinate information of an operation performed on the display panel 421 by a user with a fingertip to the control unit 410. The control unit 410 side detects a touch operation (a tap, a long-press, a flick, a swipe, or the like) of the user on the basis of the coordinate information input on the touch panel 423, and starts processing corresponding to the user operation.

The speech processing unit 430 includes a speech output unit 431 such as a speaker, a speech input unit 432 such as a microphone, and a speech codec (CODEC) 433 that performs encoding/decoding processing on an input/output speech signal. Furthermore, the speech processing unit 430 may further include a speech output terminal 434 configured to output a speech signal to a headphone (not illustrated).

The communication unit 440 performs information communication processing between an application executed by the control unit 410 and an external apparatus such as the information processing apparatus 102. The communication unit 440 includes physical layer modules such as a long term evolution (LTE) communication unit 441, a Wi-Fi (registered trademark) communication unit 442, a Bluetooth (registered trademark) low energy (BLE) communication unit 443, and near field communication (NFC) according to communication media to be used, and performs modulation/demodulation processing and encoding/decoding processing of a communication signal transmitted and received via the physical layer modules. In the present embodiment, it is assumed that sensor information is acquired from an IoT device around the information terminal 101 by communicating with the IoT device using near field or proximity communication such as Wi-Fi (registered trademark), BLE, or NFC.

The storage unit 450 includes, for example, a large-capacity storage apparatus such as an SSD or an HDD. For example, an application program and contents downloaded via the communication unit 440, image data such as a still image and a moving image captured by the imaging unit 460, and the like are stored in the storage unit 450.

The imaging unit 460 includes an image sensor such as a complementary metal oxide semiconductor (CMOS) or a charge completed device (CCD), for example, and outputs image data such as a captured photograph or a moving image to the control unit 410 via a camera interface (not illustrated).

The sensor unit 470 includes a global positioning system (GPS) sensor configured to acquire position information of the information terminal 101, a gyro sensor configured to detect a posture of a main body of the information terminal 101 and an acting force, an acceleration sensor, and the like. Furthermore, the sensor unit 470 may include a biometric sensor, such as a pulse sensor or a perspiration sensor, configured to monitor a health state of the subscriber carrying the information terminal 101, and an environmental sensor, such as a temperature sensor or a humidity sensor, a wind speed sensor, or an illuminance sensor, configured to monitor a surrounding environment.

### EXAMPLE 1

### D. Application Example to Mountain Insurance

Mountain insurance is insurance against injuries of a subscriber during climbing, theft of articles such as tools and personal items, indemnification for personal injury and property damage, and the like, in addition to an enormous search cost in a case where the subscriber is in distress during climbing. In the information processing system 100 according to the present disclosure, a period during climbing is set as an insurance coverage period, and an appropriate and fair insurance premium is determined in consideration of the subscriber's own state or states of all members of a climbing party, an environment of a mountain, and the like.

### D-1. Factors for Determining Insurance Premium

Factors for determining an insurance premium of the mountain insurance can be roughly classified into two types of static factors and dynamic factors. The static factor is a factor that does not vary during climbing, and the dynamic factor is a factor that varies during climbing. The static factor is a factor that can be determined in advance before climbing, and can be described in, for example, a subscription application form of the mountain insurance. On the other hand, as the dynamic factor, a change that occurs from moment to moment is detected using a sensor in the information terminal 101, an IoT device, and the like. In the information processing system 100 according to the present disclosure, the static factor may be treated as first information, and the dynamic factor may be treated as second information. Of course, at least some of the static factors may be treated to be included in the second information. Examples of each of the static factor and the dynamic factor are listed below.

### (1) Static Factors

Examples of a static factor for determining a mountain insurance premium include a climbing place (domestic or overseas), a climbing style (rock climbing, trail climbing, or the like) or a risk level of climbing, a climbing plan (the number of accommodation days, a season (a winter mountain, a summer mountain, or the like)), a purpose of climbing (climbing for skiing or the like), and a climbing tool to be used. Furthermore, examples of a static factor related to a subscriber can include a climbing skill of the subscriber or each member of a climbing party in which the subscriber joins. The climbing skill includes a climbing history (years of experience in climbing, the number of times of climbing, names of experienced routes, and the like).

### (2) Dynamic Factors

Examples of a dynamic factor for determining a mountain insurance premium can include a health state during climbing of a subscriber or each member of a climbing party in which the subscriber joins, weather, and a climbing environment such as a mountain state. Basically, the dynamic factor for determining the mountain insurance premium is detected using a sensor in the information terminal 101, an IoT device, and the like. The health state is a physical condition or physical strength of a subject. For example, the physical condition or physical strength of the subject can be expressed numerically using biometric information such as a blood oxygen concentration, sweating, an amount of water intake, and calorie consumption. Furthermore, the physical condition or physical strength of the subject can be estimated on the basis of a delay with respect to a path length (average movement time). The weather includes information such as actual temperature, wind speed, rain, and an amount of sunlight. An actual value of the weather information may be directly detected using the sensor in the information terminal 101, the IoT device, and the like, or may be acquired through web access to a weather site or the like. The mountain state is a difficulty level of a climbing course of this time, a state of a climbing road (wet or the like), or a state of a snowy surface (an ice burn, fresh snow, a rustle, or the like). The state of the climbing road and the state of the snowy surface may be detected using the sensor in the information terminal 101, the IoT device, and the like, or may be confirmed by the subscriber's own visual observation.

### D-2. Examples of Sensors

Sensors are mainly used to acquire dynamic factors among the factors for determining a mountain insurance premium described in Section D-1 described above. The sensors include a sensor in the information terminal 101, an IoT device, and the like. In this section, examples of the sensors that are desirably used in a case where the information processing system 100 according to the present disclosure is applied to the mountain insurance will be described.

As the sensor unit 470 in the information terminal 101, a biometric sensor, such as a pulse sensor or a perspiration sensor, configured to monitor a health state of the subscriber carrying the information terminal 101, and an environmental sensor, such as a temperature sensor or a humidity sensor, a wind speed sensor, or an illuminance sensor, configured to monitor a surrounding environment may be provided (described above). Furthermore, the information terminal 101 may acquire sensor information related to the dynamic factors of climbing from a surrounding IoT device through near field communication or proximity communication. The IoT device may be a wearable device (a watch, shoes, glasses, or the like) worn by a subscriber on the body when climbing a mountain, or may be a device installed on a route of the mountain insurance (such as an instrument shelter). Sensors useful for measuring the dynamic factors of climbing and items that can be measured by the respective sensors will be exemplified below.

(1) Smart Watch

A biometric sensor or the like is mounted on a watch main body, by utilizing direct contact between the watch and a skin of an arm and the following items including subscriber's own biometric information are measured.
GPS or position information
Blood oxygen concentration
Amount of activity (calorie consumption)
Heart rate, pulse wave, body temperature, blood pressure, sweating
Movement distance, number of steps
Height difference

(2) Weather Sensor
Temperature, humidity, illuminance, wind speed, rainfall, snowfall, and frost

(3) Shoe Sensor

A shoe sensor includes an inertial measurement unit (IMU), a plantar pressure sensor, and the like which are attached to climbing shoes, and measures the following items.
Movement of center of gravity, impact at landing, slip, change in weight
Stride, number of steps, movement distance

(4) Smart Glass or Goggle

A smart glass or goggle is of a spectacle type to be worn at a position of a head or an eye, and thus, there are advantages that a sensor can be mounted to perform measurement with high sensitivity, that radio waves can be received with high sensitivity, and that a camera is mounted to capture an image of a field of view of a wearer and collect various types of information by analysis of the image. The smart glass or goggle measures the following items.
GPS or position information
State of climbing road and state of rain, snowing, or frost based on image recognition
Weather analysis based on image imaging upper air

Note that the types of sensors and some of the items measured by the respective sensors described in (1) to (4) described above may overlap with the sensor unit 470 provided in the information terminal 101, and in such a case, sensor information acquired from either of the sensors may be used. Furthermore, some sensor information such as the weather sensor may use information acquired from a web site by the information terminal 101 or the information processing apparatus 102 instead of directly measured sensor information.

### D-3. Configuration of Mountain Insurance

In a case of climbing a mountain alone, a total amount of a mountain insurance premium is determined only on a condition of a subscriber himself/herself. On the other hand, an insurance premium in a case of climbing a mountain in a party includes a base insurance premium that is an insurance premium common to all members of the climbing party and a personal insurance premium determined for each of the members, and a mountain insurance premium of each of the members is determined by a sum of the base insurance premium and the personal insurance premium.

In Sections A and B described above, it has been described that, when the subscriber performs the insurance subscription procedure using his/her own information terminal 101 in the information processing system 100 according to the present disclosure, the first insurance premium is calculated on the basis of the first information acquired from the information terminal 101, the second insurance premium is calculated on the basis of the second information acquired through the information terminal 101 or the like of the subscriber while the subscriber is performing activities related to a sport or a hobby to be covered by the insurance during the coverage period of the insurance, and the total amount of the first insurance premium and the second insurance premium is determined as the insurance premium of the subscriber. The base insurance premium and the personal insurance premium in the mountain insurance each include the first insurance premium determined on the basis of description contents of an insurance application at the time of subscribing to the insurance and the second insurance premium determined on the basis of the state (state of each of the members and the environment such as the weather) acquired during climbing.

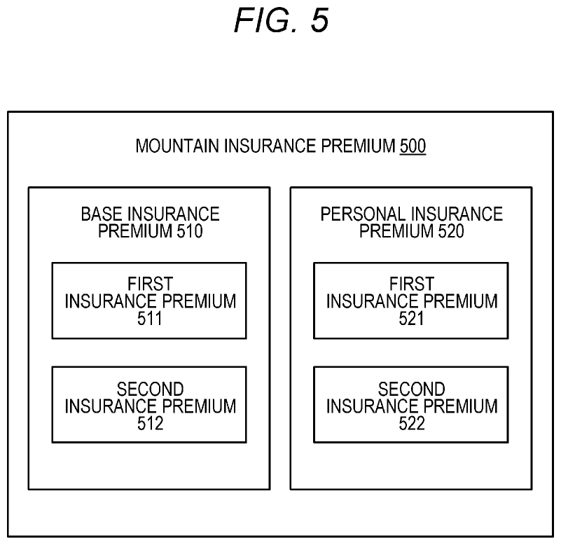

FIG. 5 schematically illustrates a configuration example of a mountain insurance premium 500 in climbing in a party. As described above, the mountain insurance premium 500 includes a base insurance premium 510 and a personal insurance premium 520.

A first insurance premium 511 of the base insurance premium 510 is determined by comprehensively evaluating a climbing history and a climbing skill level of each of the members of the climbing party. Furthermore, a first insurance premium 521 of the personal insurance premium 520 is determined by evaluating a state of an individual member such as a health state of each of the members.

A second insurance premium 512 of the base insurance premium 510 is calculated from a group risk of the entire party assessed on the basis of the states of the respective members of the party sensed during climbing. Furthermore, a second insurance premium 522 of the personal insurance premium 520 is calculated from a personal risk assessed on the basis of the health state of each of the members sensed during climbing and the environment (weather, a state of a climbing course, or the like).

The base insurance premium 510 is an insurance premium uniformly imposed on all the members of the climbing party at the time of subscribing to the mountain insurance. On the other hand, the personal insurance premium 520 may be an option that can be arbitrarily selected for each of the members.

### D-4. Examples of Use Cases

In this section, use cases in a case where the information processing system 100 according to the present disclosure is applied to a mountain insurance service will described separately for each of phases, that is, before climbing, during climbing, and after climbing.

### D-4-1. Before Climbing

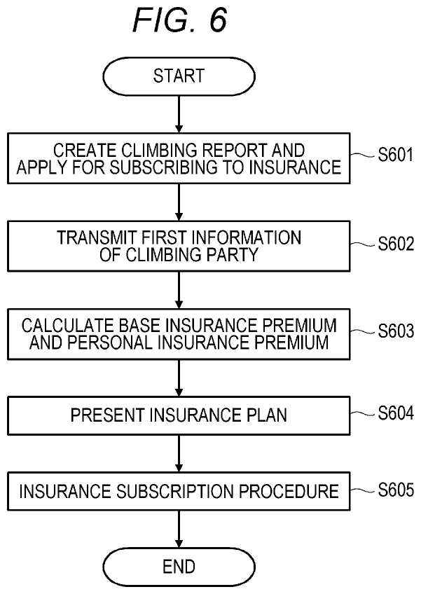

FIG. 6 illustrates a procedure performed by the information processing system 100 before climbing or at the time of subscribing to the mountain insurance in a flowchart format.

First, a leader of a climbing party creates a climbing report as a representative, and performs a procedure for subscribing to the mountain insurance (step S601).

In the procedure for subscribing to the mountain insurance, the leader applies for subscribing to the mountain insurance by web access to the information processing apparatus 102 through his information terminal 101. In response, the information processing apparatus 102 returns subscription guidance for the mountain insurance. The leader transmits the subscription guidance to each of members of the climbing party by e-mail or the like. Each of the members enters his name, gender, age, occupation, address, climbing history, and climbing skill level as a reply for the leader. Then, the leader collects pieces of information of the respective members, and transmits, to the information processing apparatus 102, an application for subscription to the mountain insurance of the climbing party including a climbing place (domestic or overseas), a climbing style (rock climbing, trail climbing, or the like) or a risk level of climbing, a climbing plan (the number of accommodation days, a season (a winter mountain, a summer mountain, or the like)), a purpose of climbing (climbing for skiing or the like), and the like.

The information processing apparatus 102 can acquire first information regarding the climbing party or each of the members through the subscription application procedure from the information terminal 101 of the leader (step S602). Examples of the first information acquired in the subscription application procedure of the climbing party are listed below.
Two nights and three days from July 14, traveling along a general route from Mt. Yari to Mt. Okuhotaka, and tent stay
Mr. A (60-year-old male): Mr. A is expert with climbing history of 20 years and is leader of climbing of this time
Mr. B (40-year-old male): Climbing history of ten years
Mr. C (35-year-old male): Climbing history of five years
Weather forecast: Light rain, clear after cloudy, and clear

Then, the information processing apparatus 102 assesses a group risk of the entire climbing party on the basis of the climbing histories, climbing skill levels, the weather forecast of mountains scheduled to be climbed, and the like of all the members of the climbing party, and calculates the first insurance premium 511 of the base insurance premium 510. Furthermore, the information processing apparatus 102 assesses a personal risk for each of the members on the basis of a health state or the like of each of the members, and calculates the first insurance premium 521 of the personal insurance premium 520 (step S603). For example, the base insurance premium of the mountain insurance of this time is 1000 yen/day per person.

Next, the information processing apparatus 102 presents a mountain insurance plan proposed to the climbing party including the information of the base insurance premium and the personal insurance premiums calculated in step S603 (step S604).

A method for presenting the mountain insurance plan is not particularly limited. The information processing apparatus 102 may transmit the mountain insurance plan to the information terminal 101 of the leader by e-mail such that the leader transfers the mountain insurance plan to the information terminals 101 of the other members, or the information processing apparatus 102 may transmit the mountain insurance plan to the information terminals 101 of the respective members of the climbing party. For example, an optional personal insurance premium of each of the members of the mountain insurance of this time is 0 yen.

The leader of the climbing party confirms contents of the proposed mountain insurance plan with his information terminal 101 and performs the insurance procedure (step S605). The presented mountain insurance plan also includes information of the base insurance premium and personal insurance premiums calculated on the basis of the information before climbing. In a case of subscribing to the mountain insurance according to the presented plan, the information processing apparatus 102 determines the uniform base insurance premium for all the members including the leader. Furthermore, the information processing apparatus 102 determines an insurance premium obtained by adding the base insurance premium and the personal insurance premium for the member who has selected the option of the personal insurance.

### D-4-2. During Climbing

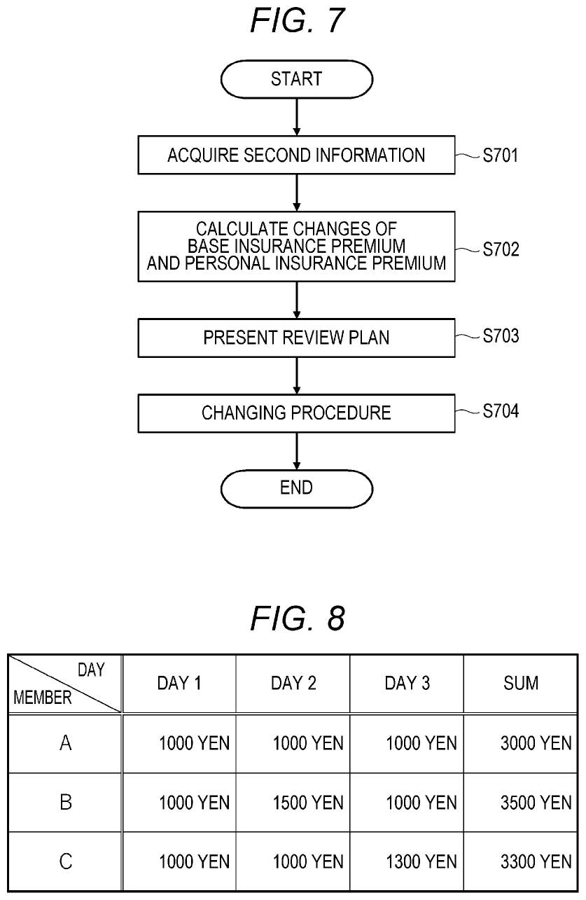

FIG. 7 illustrates a procedure performed by the information processing system 100 while the climbing party is climbing the mountains in a flowchart format. Here, it is assumed that the climbing party has subscribed to the mountain insurance through the procedure described in Section D-4-1 described above. Furthermore, it is assumed that the optional personal insurance premium of each of the members of the climbing party is 0 yen.

The information processing apparatus 102 acquires second information from the information terminal 101 and an IoT device of the leader of the climbing party or each of the members (step S701).

The second information includes information regarding an environment such as a health state of each of the members, weather of the mountains during climbing, and a state of a climbing course which are detected by the sensor unit 470 in the information terminal 101 and the IoT device. The information processing apparatus 102 may acquire some of the second information, for example, the weather, the state of the climbing course, or the like from a web site instead of the information terminal 101.

Then, the information processing apparatus 102 comprehensively assesses a group risk on the basis of the states of the respective members during climbing acquired as the second information, and calculates the second insurance premium 512 of the base insurance premium 510. Furthermore, the information processing apparatus 102 assesses a personal risk on the basis of the health state of each of the members during climbing, the weather of the mountains during climbing, and the state of the climbing course, and calculates the second insurance premium 522 of the personal insurance premium 520 (step S702).

Here, the second insurance premiums 512 and 522 are calculated as changes of the respective first insurance premiums 511 and 521 calculated before climbing. For example, if the group risk increases because the weather or the climbing course becomes worse than predictions before climbing, the base insurance premium 510 increases. The information processing apparatus 102 calculates the second insurance premium 512 which is an increased amount of the base insurance premium 510 relative to the first insurance premium 511. Furthermore, if a health state of a member who is climbing deteriorates by suffering from altitude sickness or the like so that a personal risk of the member increases, a personal insurance premium of the member increases. The information processing apparatus 102 calculates a second insurance premium that is an increased amount of the personal insurance premium 520 of the member relative to the first insurance premium 521.

Next, the information processing apparatus 102 presents a review plan of the subscribed mountain insurance including information regarding increased or decreased amounts of the base insurance premium and the personal insurance premiums on the basis of the second insurance premiums 512 and 522 calculated in step S702 (step S703).

A method for presenting the review plan is not particularly limited. The information processing apparatus 102 may transmit the review plan to the information terminal 101 of the leader by e-mail such that the leader transfers the review plan to the information terminal 101 of the other members, or the information processing apparatus 102 may transmit the review plan to the information terminals 101 of the respective members of the climbing party.

The leader of the climbing party confirms contents of the proposed review plan with his information terminal 101 and performs a procedure for changing the subscribed mountain insurance (step S704). The presented review plan also includes information of changed amounts relative to the base insurance premium and the personal insurance premiums calculated on the basis of the information before climbing. In a case where the mountain insurance is changed according to the presented review plan, the information processing apparatus 102 determines the changed amount of the base insurance premiums for all the members including the leader. Furthermore, the information processing apparatus 102 determines an insurance premium changed by the changed amount of the base insurance premium and the changed amount of the personal insurance premium for the member who has selected the option of the personal insurance.

Note that the information processing apparatus 102 may perform the acquisition of the second information and the calculation of the second insurance premium, that is, the review of the mountain insurance premium, for example, at predetermined time intervals. For example, the acquisition of the second information and the calculation of the second insurance premium may be performed once a day, or may be performed a plurality of times a day. Alternatively, the acquisition of the second information and the calculation of the second insurance premium may be performed only once during climbing in an insurance coverage period. If the frequency of performing the acquisition of the second information and the calculation of the second insurance premium is increased, a more appropriate and fairer mountain insurance premium can be calculated, but a processing load of the information processing apparatus 102 increases. Furthermore, if the frequency of performing the acquisition of the second information and the calculation of the second insurance premium is reduced, the processing load of the information processing apparatus 102 can be suppressed to be low, but there is a possibility that the mountain insurance premium charged to the climbing party may become an amount inappropriate or unfair to an actual risk.

Hereinafter, an example of a use case in a case where an insurance premium is reviewed every day in the climbing course of two nights and three days will be described.
Day 1: Weather recovery is delayed, and a rocky area of Mt. Yari is wet. Since a risk level of slipping and falling becomes slightly higher, a personal insurance premium of Mr. B who wears old climbing shoes has been added by 500 yen in a review plan (the information processing apparatus 102 has calculated +500 yen as the second insurance premium 522 of Mr. B).
Day 2: Since an average blood oxygen concentration of Mr. C at last night has decreased, the possibility of suffering from altitude sickness increases, and thus, a personal insurance premium of Mr. C has been added by 300 yen in a review plan (the information processing apparatus 102 has calculated +300 yen as the second insurance premium 522 of Mr. C). Furthermore, in the review plan, it is proposed that Mr. C take DIAMOX and be frequently hydrated together with the increased amount of the personal insurance premium of Mr. C. Furthermore, the risk of the entire climbing party increases, but the base insurance premium is not changed in the review plan (the information processing apparatus 102 has calculated 0 yen as the second insurance premium 512 of the base insurance premium 510).
Day 3: It is proposed to return the mountain insurance premium to the original base insurance premium as a review plan on the basis of second information such as sensor information from the information terminal 101 and the IoT device of each of the members, a weather forecast, and the remaining climbing course of going down the mountain (the information processing apparatus 102 has assessed the remaining group risk and personal risk on the basis of the second information and calculated 0 yen as the second insurance premium 512).

### D-4-3. After Climbing

As described in Section D-4-1 described above, the base insurance premium of the mountain insurance of this time was proposed as 1000 yen/day per person before climbing, and the climbing party subscribed to the mountain insurance under such a condition. Furthermore, as described in Section D-4-2 described above, on the basis of the second information acquired from the information terminal 101 of each of the members during climbing, the IoT device, the web site, or the like, the increased amount of 500 yen in the personal insurance premium of Mr. B was proposed on Day 2, and the increased amount of 300 yen in the personal insurance premium of Mr. C was proposed on Day 3. It is assumed that both Mr. B and Mr. C complied with the increased amounts of personal insurance premiums. Furthermore, on Day 3, it was proposed to return the base insurance premium to the original amount, and the base insurance premium was returned to the original amount. FIG. 8 illustrates transitions of insurance premiums of each of the members of the climbing party during climbing for two nights and three days. Finally confirmed insurance premiums of the respective members A to C are as follows as illustrated in FIG. 8.
Mr. A: 3000 yen
Mr. B: 3500 yen
Mr. C: 3300 yen

The information processing apparatus 102 charges the finally confirmed mountain insurance premiums to the respective members A to C. For example, the information processing apparatus 102 transmits e-mails to the information terminals 101 possessed by the respective members A to C, and presents the finally confirmed mountain insurance premiums. The respective members A to C may perform a mountain insurance premium payment procedure at the same time directly on screens on which their own mountain insurance premiums are presented.

### D-5. Functional Configuration

In this section, a functional configuration for calculating an insurance premium of the mountain insurance to which the climbing party subscribes in the information processing apparatus 102 will be described separately for the first insurance premium calculation before climbing and the second insurance premium calculation during climbing.

### D-5-1. First Insurance Premium Calculation

The configuration of the mountain insurance premium as illustrated in FIG. 5 is applied. The mountain insurance premium 500 includes the base insurance premium 510 and the personal insurance premium 520. Then, the base insurance premium 510 is an insurance premium uniformly imposed on all the members of the climbing party, and includes the first insurance premium 511 determined before climbing and the second insurance premium 512 determined during climbing. Furthermore, the personal insurance premium 520 is an insurance premium which is an individual option for each of the members of the climbing party, and includes the first insurance premium 521 determined before climbing and the second insurance premium 522 determined during climbing.

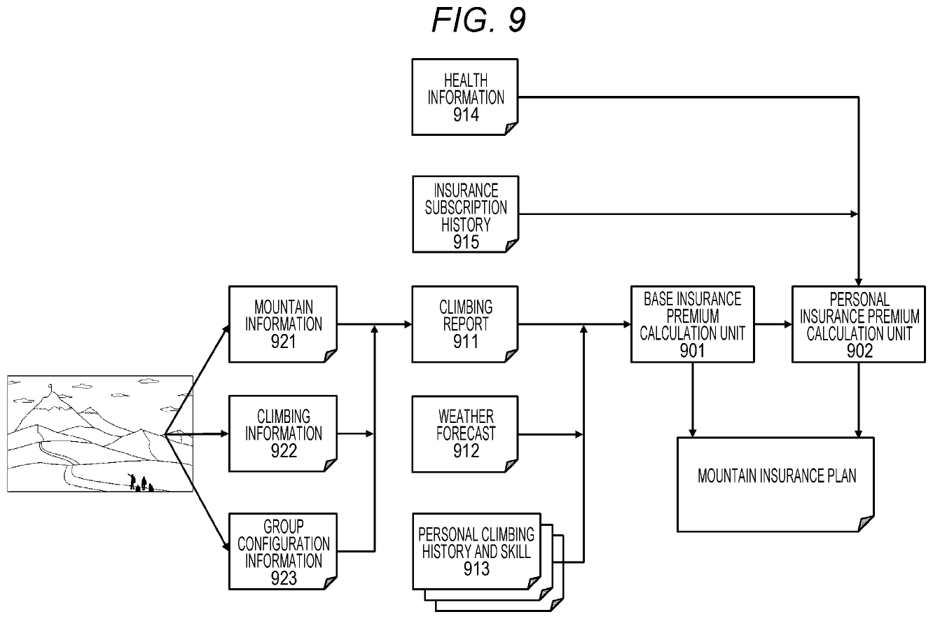

FIG. 9 illustrates a functional configuration example for the information processing apparatus 102 to calculate a first insurance premium of the mountain insurance. The information processing apparatus 102 includes a base insurance premium calculation unit 901 and a personal insurance premium calculation unit 902 in order to calculate the first insurance premium of the mountain insurance premium. The base insurance premium calculation unit 901 calculates the first insurance premium 511 of the base insurance premium 510, and the personal insurance premium calculation unit 902 calculates the first insurance premium 521 of the personal insurance premium 520. In the system configuration example illustrated in FIGS. 1 and 2, the base insurance premium calculation unit 901 and the personal insurance premium calculation unit 902 are arranged in the information processing apparatus 102. However, in a case where an insurance application executed on the information terminal 101 performs the mountain insurance premium calculation processing, the base insurance premium calculation unit 901 and the personal insurance premium calculation unit 902 are respectively implemented as functional modules of the insurance application. A method for calculating the first insurance premiums 511 and 512 will be described in detail with reference to FIG. 9.

The leader of the climbing party compiles mountain information 921 regarding a mountain where climbing is planned, climbing information 922, and group configuration information 923 to create a climbing report 911. The mountain information 921 is information regarding the mountain to be climbed. Detailed information of the mountain can also be collected from a web site, and the mountain information 921 may be only information that can identify a mountain, such as a mountain name. The climbing information 922 includes information regarding a climbing plan such as a climbing style, a climbing date, the number of accommodation days, and a purpose of climbing. The group configuration information 923 includes personal information such as gender and age of each of the members of the climbing party. The leader of the climbing party transmits, to the information processing apparatus 102, an application for subscription to the mountain insurance conforming to description contents of the climbing report 911 on his information terminal 101.

In addition to the climbing report 911 (or the application for subscription to mountain insurance conforming to the description contents of the climbing report 911), the base insurance premium calculation unit 901 collects first information including a weather forecast 912 of the day of climbing of the mountain where the climbing is planned, and personal climbing history and skill information 913 including a climbing history and a skill level of each of the members of the climbing party. The weather forecast 912 may be acquired from a web site. Then, the base insurance premium calculation unit 901 assesses a group risk of the climbing party from the collected first information, and calculates the first insurance premium 511 of the base insurance premium 510 on the basis of the assessed group risk.

The personal insurance premium calculation unit 902 calculates the first insurance premium 521 of the personal insurance premium 520 for each of the members on the basis of the first information of each of the members including health information 914 and insurance subscription history information 915 of each of the members in the climbing party. The health information, the insurance subscription history information, and other personal information of the member having a previous subscription history are accumulated in the storage apparatus 320.

Then, the information processing apparatus 102 presents a mountain insurance plan including information of the first insurance premium 511 of the base insurance premium 510 calculated by the base insurance premium calculation unit 901 and the first insurance premium 521 of the personal insurance premium 520 calculated by the personal insurance premium calculation unit 902 to the climbing party. A method for presenting the mountain insurance plan is not particularly limited. The information processing apparatus 102 may transmit the mountain insurance plan to the information terminal 101 of the leader by e-mail such that the leader transfers the mountain insurance plan to the information terminals 101 of the other members.

### D-5-2. Second Insurance Premium Calculation

As illustrated in FIG. 5, a second insurance premium of the mountain insurance 500 includes the second insurance premium 512 of the base insurance premium 510 and the second insurance premium 522 of the personal insurance premium 520. The second insurance premium 512 of the base insurance premium 510 is a change of the first insurance premium 511 of the base insurance premium 510 calculated before climbing, the change occurring during climbing. Furthermore, the second insurance premium 522 of the personal insurance premium 520 is a change of the first insurance premium 521 of the personal insurance premium 520 calculated before climbing, the change occurring during climbing.

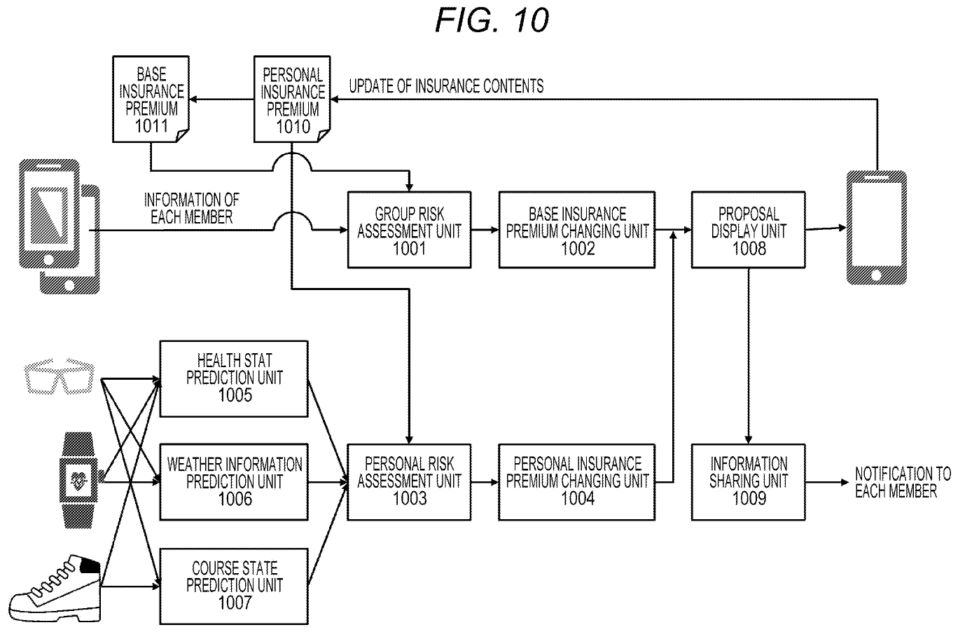

FIG. 10 illustrates a functional configuration example for the information processing apparatus 102 to calculate the second insurance premium of the mountain insurance. The information processing apparatus 102 includes a group risk assessment unit 1001, a base insurance premium changing unit 1002, a personal risk assessment unit 1003, and a personal insurance premium changing unit 1004 in order to calculate the second insurance premium out of a mountain insurance premium.

The group risk assessment unit 1001 assesses a group risk of the entire climbing party during climbing on the basis of current base insurance contents (an increased amount of an insurance premium) and a state of each of the members of the climbing party (a risk of each of the members). The state of each of the members can be collected from, for example, the information terminal 101 managed by each of the members and an IoT device. The group risk assessment unit 1001 may assess the group risk using a deep-learned learning model.

The base insurance premium changing unit 1002 calculates the second insurance premium 512 that is a change, which has occurred during climbing, of the first insurance premium 511 of the base insurance premium 510 calculated before climbing on the basis of the assessment result of the group risk. The base insurance premium changing unit 1002 may calculate the second insurance premium 512 using a deep-learned learning model.

The personal risk assessment unit 1003 assesses a personal risk of suffering from damage such as an injury for each of the members on the basis of a health state of each of the members during climbing, weather of a mountain during climbing, and a state of a climbing course during climbing. The personal risk assessment unit 1003 may assess the personal risk during a climbing period using a deep-learned learning model.

Furthermore, the information processing apparatus 102 includes a health state prediction unit 1005 that predicts a health state of each of the members, a weather information prediction unit 1006 that predicts weather of the climbing course, and a course state prediction unit 1007 that predicts a state of the climbing course in order to predict the health state of each of the members during climbing, the weather of the mountain, and the state of the climbing course necessary for the assessment of the personal risk on the basis of sensor information by the information terminal 101 possessed by each of the members and the IoT device.

The personal insurance premium changing unit 1004 calculates the second insurance premium 522 that is a change, which has occurred due to a risk variation during climbing, of the first insurance premium 521 of the personal insurance premium 520 calculated at the time of subscribing to the insurance or before climbing on the basis of the assessment result of the personal risk obtained by the personal risk assessment unit 1003. The personal insurance premium changing unit 1004 may calculate the second insurance premium 522 using a deep-learned learning model.

Then, the information processing apparatus 102 includes a proposal presentation unit 1008 that proposes a review plan of the mountain insurance to the climbing party on the basis of the second insurance premium 512 of the base insurance premium 510 calculated by the base insurance premium changing unit 1002 and the second insurance premium 522 of the personal insurance premium 520 calculated by the personal insurance premium changing unit 1004, and an information sharing unit 1009 for sharing information regarding the review of the mountain insurance among the members of the climbing party. The proposal presentation unit 1008 notifies the information terminal 101 of the leader of the climbing party of the review plan of the mountain insurance by e-mail transmission or the like, for example. Furthermore, the information sharing unit 1009 notifies each of the members of the review plan of the mountain insurance by e-mail transmission or the like.

The leader of the climbing party compiles opinions within the climbing party regarding the change of the base insurance premium and the change of the personal insurance premium of each of the members, and requests the information processing apparatus 102 from the his information terminal 101 to update the insurance contents. The information processing apparatus 102 side updates a personal insurance premium 1010 of each of the members and updates a base insurance premium 1011 in response to the request for updating the insurance contents from the information terminal 101.

Note that at least some of the functional modules 1001 to 1009 illustrated in FIG. 10 may be arranged not on the information processing apparatus 102 but on the information terminal 101 possessed by a subscriber (the leader of the climbing party or the like). For example, at least some functions of the functional modules 1001 to 1009 may be implemented as operations of an insurance application started on the information terminal 101.

Next, each of the prediction units 1005 to 1007 configured to assess the personal risk during climbing will be described.

Each of the prediction units 1005 to 1007 performs prediction on the basis of sensor information from the sensor unit 470 in the information terminal 101 and an IoT device and information acquired from a web site. The IoT device include a smart watch, a smart glass or goggle, a shoe sensor, or the like. Regarding the sensor information measured by each of the IoT devices, Section D-2 described above may referred to. Basically, each of the prediction units 1005 to 1007 uses the sensor information from the sensor unit 470 in the information terminal 101 and the IoT device, and the information acquired from the web site as explanatory variables, and performs processing of calculating a desired objective variable from the explanatory variables on the basis of each of prediction models.

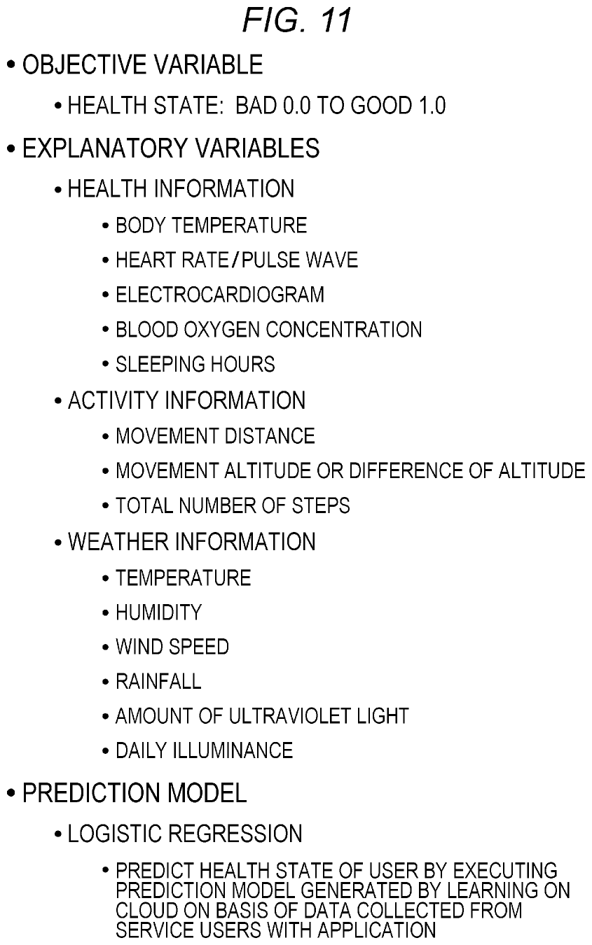

The health state prediction unit 1005 predicts a health state of each of the members on the basis of the sensor information from the sensor unit 470 in the information terminal 101 and the IoT device. The health state prediction unit 1005 calculates an objective variable using a prediction model on the basis of logistic regression from explanatory variables including health information, activity information, and weather information, with the health state represented by a value of 0.0 to 1.0 as the objective variable. FIG. 11 illustrates details of the objective variable, the explanatory variables, and the prediction model in the health state prediction unit 1005. Among the explanatory variables, the health information includes a body temperature, a heart rate or a pulse wave, an electrocardiogram, a blood oxygen concentration, and sleeping hours. Among the explanatory variables, the activity information includes a movement distance, movement altitude or a difference of altitude, and a total number of steps. Furthermore, among the explanatory variables, the weather information includes temperature, humidity, wind speed, rainfall, an amount of ultraviolet light, and daily illuminance. The prediction model based on the logistic regression predicts the health state by the prediction model generated by learning on, for example, a cloud using data collected from a large number of insurance subscribers.

The weather information prediction unit 1006 measures current weather of the climbing course on the basis of the sensor information from the sensor unit 470 in the information terminal 101 and the IoT device. Furthermore, the weather information prediction unit 1006 predicts the weather of the remaining climbing course from a weather forecast acquired by accessing a weather forecast site on the Web.

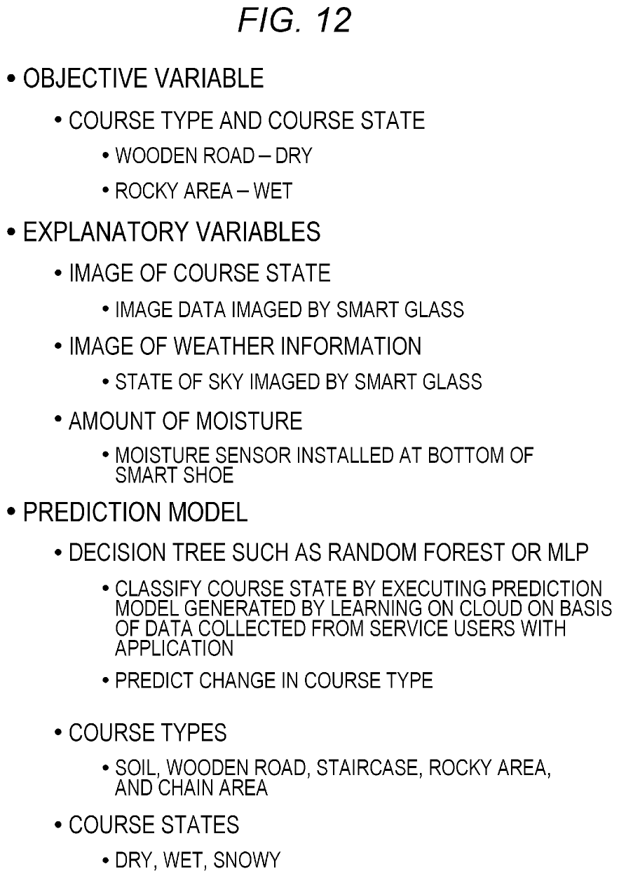

The course state prediction unit 1007 predicts the state of the climbing course on the basis of sensor information from the sensor unit 470 in the information terminal 101 and the IoT device. The course state prediction unit 1007 calculates objective variables from explanatory variables including an image of the climbing course, an image of weather information, and an amount of water using a prediction model based on a decision tree such as random forest or multilayer perceptron (MLP), with a type of the climbing course and the state of the course as the objective variables. FIG. 12 illustrates details of the objective variables, the explanatory variables, and the prediction model in the course state prediction unit 1007. The course type as the objective variable includes soil, a wooden road, a staircase, a rocky area, and a chain area. Furthermore, course states of the respective course types are represented by dry, wet, and snowy. Among the explanatory variables, the image of the climbing course is, for example, an image of the climbing course captured by a smart glass, the image of the weather information is an image of the sky captured by the smart glass, and the amount of water is an amount of water measured by a water amount sensor installed at the bottom of a climbing shoe. The prediction model based on the random forest or the MLP classifies the state of the climbing course by executing a prediction model generated by learning on, for example, a cloud using data collected from a large number of insurance subscribers. The prediction model predicts the state of the climbing course every time the course type changes.

### D-6. Specific Examples of Risk Assessment and Insurance Premium Calculation

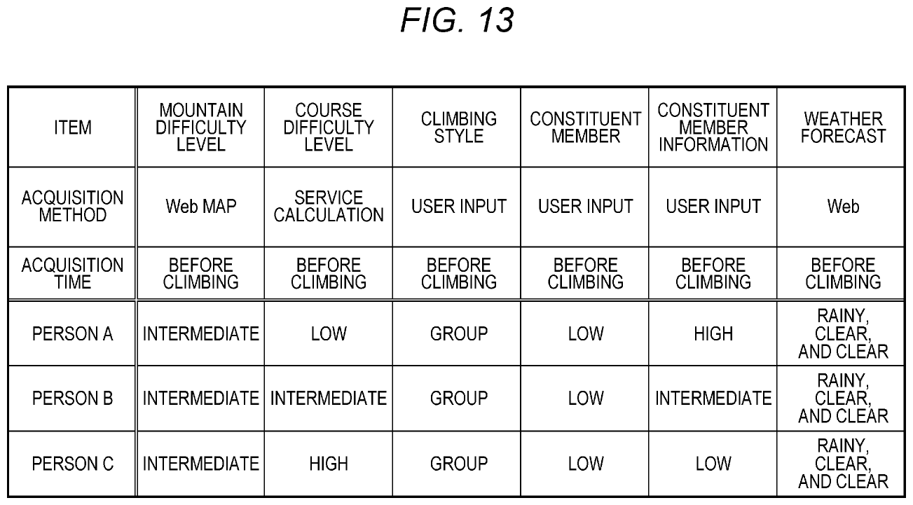

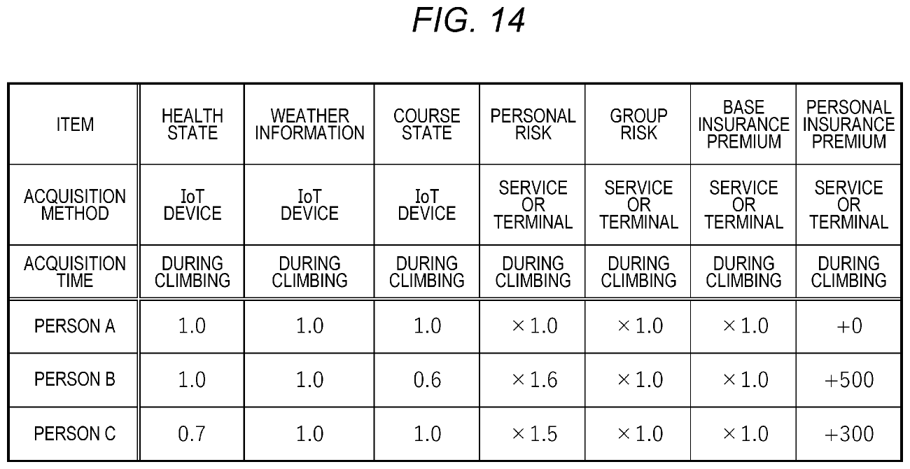

FIG. 13 illustrates types of first information acquired by the information processing system 100 to calculate a first insurance premium of the mountain insurance before climbing (for example, when the climbing party subscribes to the mountain insurance), an acquisition method of each piece of the information, and input examples of the respective members A to C of the climbing party.

A mountain difficulty level can be acquired from a web map on the basis of, for example, the mountain information 921 (mountain name or the like) described in the climbing report 911. Furthermore, a course difficulty level is automatically calculated by a mountain insurance service side (or the information processing apparatus 102) on the basis of a climbing route described in the climbing report 911, for example. Furthermore, a climbing style, a constituent member, and a constituent member skill can be acquired on the basis of a user input, for example, by the leader of the climbing party makes a report with the climbing report 911. Furthermore, the weather forecast can be acquired by web access to a weather forecast site or the like on the basis of the mountain information 921 and a climbing date described in the climbing report 911.

FIG. 14 illustrates types of second information acquired by the information processing system 100 to calculate a second insurance premium during climbing (or during a coverage period of the subscribed mountain insurance), an acquisition method of each piece of the information, and input examples of the respective members A to C of the climbing party. Furthermore, FIG. 14 also illustrates a personal risk of each of the members assessed on the basis of the input example of the second information of each of Members A to C, a group risk of the climbing party, a changed base insurance premium that is uniform for the members of the climbing party, and changed personal insurance premiums of the respective members.

During climbing, as the second information of each of the members, health information, weather information, and a course state can be acquired from a smart glass, a smart watch, a shoe sensor, or other IoT devices. In the example illustrated in FIG. 14, the acquired health information, weather information, and course state are indicated by score values normalized to values between 0 and 1.0.

The information processing system 100 assesses the group risk of the entire climbing party and the personal risk of each of the members on the basis of the first information acquired before climbing as illustrated in FIG. 13. Moreover, the information processing system 100 sequentially assesses the group risk of the entire climbing party and the personal risk of each of the members during climbing on the basis of the second information acquired during climbing as illustrated in FIG. 14.

As described in Section D-4-2 described above, a score value of a course state of Mr. B wearing the old climbing shoes decreases to 0.6, and a score value of health information of Mr. C whose average blood oxygen concentration has decreased decreases to 0.7. As a result, a personal risk of Mr. B increases by 1.6 times, and the personal risk of Mr. C increases by 1.5 times. On the other hand, the group risk does not vary.

Then, the information processing system 100 calculates a change of the base insurance premium that is uniform for the entire climbing party on the basis of the assessment result of the group risk for the entire climbing party during climbing, calculates a change of the personal insurance premium for each of the members on the basis of the assessment result of the personal risk of each of the members during climbing, and determines a final mountain insurance premium of each of the members.

Since the group risk does not vary, the base insurance premium is not changed. Since the personal risk of Mr. B has increased by 1.6 times, a personal insurance premium of Mr. B is added by 500 yen. Furthermore, a personal insurance premium of Mr. C is added by 300 yen since the personal risk of Mr. C has increased by 1.5 times.

Estimation of the personal risk and the group risk and review of the base insurance premium and the personal insurance premium may be performed by the mountain insurance service side (or the information processing apparatus 102), or may be performed on the information terminal 101 of each of the members.

### EXAMPLE 2

### E. Application Example to Golf Insurance

Golf insurance is insurance against subscriber's injuries or illnesses (heatstroke or the like) during play, damage of golf instruments such as clubs, theft of articles such as tools and personal items, expenses for gifts and celebrations for hole-in-one or double eagle, indemnification for damage of persons (a partner, a player of a preceding group, and the like) and property, and the like.

### E-1. Factors for Determining Insurance Premium

Factors for determining an insurance premium of the golf insurance can be roughly classified into two types of static factors and dynamic factors. The static factor is a factor that does not vary during play, and the dynamic factor is a factor that varies during play. The static factor is a factor that can be determined in advance before play, and can be described in, for example, a subscription application form of the golf insurance. On the other hand, as the dynamic factor, a change that occurs from moment to moment is detected using a sensor in the information terminal 101, an IoT device, and the like. In the information processing system 100 according to the present disclosure, the static factor may be treated as first information, and the dynamic factor may be treated as second information. Of course, at least some of the static factors may be treated to be included in the second information. Examples of each of the static factor and the dynamic factor are listed below.

### (1) Static Factors

Examples of the static factor for determining a golf insurance premium can include a name of a country club, or features of a golf course (course classifications (a mountainous course, a hill course, a woods course, and the like), a course difficulty level, and a course feature), and a golf tool to be used. Furthermore, examples of the static factor related to a subscriber can include a skill and a golf history of the subscriber. The golf skill may be indicated by a swing level. The swing level can be expressed using numerical values of factors, for example, a slice, a fat shot, a hook, directionality, a meet rate, a tempo, and the like. Furthermore, a golf history can be indicated by past scores, a score average, or a handicap, rather than simple years of play.

### (2) Dynamic Factors

Examples of the dynamic factor for determining a golf insurance premium can include a subscriber's own health state during play, a state of the golf course, a playing environment such as weather of the golf course, and the like. Basically, the dynamic factor for determining the golf insurance premium is detected using a sensor in the information terminal 101, an IoT device, and the like. The health state is a physical condition or physical strength of the subscriber who plays golf. The health state is affected by, for example, sleeping hours on a previous day, a play start time, the, temperature during play, wind speed, rain, and an amount of sunlight. The state of the golf course includes states of grass on the day of play (wet, dry, tough grass, and the like). Furthermore, the course difficulty level and the course feature may be treated as the dynamic factors. The course feature includes, for example, information of a course shape (a right dogleg (DL) or a left dogleg, many or few short courses, many or few long courses, and the like).

### E-2. Examples of Sensors

Sensors are mainly used to acquire dynamic factors among the factors for determining a golf insurance premium described in Section E-1 described above. The sensors include a sensor in the information terminal 101, an IoT device, and the like. In this section, examples of the sensors that are desirably used in a case where the information processing system 100 according to the present disclosure is applied to the golf insurance will be described.

As the sensor unit 470 in the information terminal 101, a biometric sensor, such as a pulse sensor or a perspiration sensor, configured to monitor a health state of the subscriber carrying the information terminal 101, and an environmental sensor, such as a temperature sensor or a humidity sensor, a wind speed sensor, or an illuminance sensor, configured to monitor a surrounding environment may be provided (described above). Furthermore, the information terminal 101 may acquire sensor information related to the dynamic factors of golf play from a surrounding IoT device through near field communication or proximity communication. The IoT device may be a wearable device (a watch, shoes, glasses, or the like) worn by a subscriber on the body during play or may be a device installed on a golf course (such as an instrument shelter). Sensors useful for measuring the dynamic factors of the golf insurance and items that can be measured by the respective sensors will be exemplified below.
(1) Smart Watch

A biometric sensor or the like is mounted on a watch main body, by utilizing direct contact between the watch and a skin of an arm and the following items including subscriber's own biometric information are measured.
GPS or position information
Blood oxygen concentration
Amount of activity (calorie consumption)
Heart rate, pulse wave, body temperature, blood pressure, sweating
Movement distance, number of steps
Height difference

(2) Weather Sensor
Temperature, humidity, illuminance, and wind speed

In the golf insurance, it is unnecessary to detect a rainfall, a snowfall, and a frost on the assumption that there is no play in bad weather, which is different from the case of a mountain insurance.

(3) Swing Analysis Sensor

Swing analysis sensors visualize and quantify, for example, a head speed, a driving distance, a swing form, and the like. There are various types such as a swing analysis sensor attached to a grip portion, a wristwatch-type swing analysis sensor, and analysis software for analyzing a swing form imaged by a smartphone or the like. Furthermore, there are a type of swing analysis sensor used in a driving range and a type of swing analysis sensor used on a course. The swing analysis sensor may be used in a driving range to detect a golf skill such as the swing level as the static factor. Furthermore, a result detected on the course using the swing analysis sensor may be used as the dynamic factor.

(4) Score and Course Detection Sensor

For example, a GPS navigation system for golf or the like is used to record a course, a score, and a position of a ball in the actual course.

(5) Shoe Sensor

A shoe sensor includes an IMU, a plantar pressure sensor, and the like which are attached to golf shoes, and measures the following items.
Movement of center of gravity, impact at landing, slip, change in weight
Stride, number of steps, movement distance

Note that the types of sensors and some of the items measured by the respective sensors described in (1) to (5) described above may overlap with the sensor unit 470 provided in the information terminal 101, and in such a case, sensor information acquired from either of the sensors may be used. Furthermore, some sensor information such as the weather sensor may use information acquired from a web site by the information terminal 101 or the information processing apparatus 102 instead of directly measured sensor information.

### E-3. Configuration of Golf Insurance

The golf insurance includes a base insurance premium determined by an insurance company as a fixed amount on the basis of past data, and a personal insurance premium added to the base insurance premium by evaluating a state of an individual, and a golf insurance premium is determined by a sum of the base insurance premium and the personal insurance premium.

In Sections A and B described above, it has been described that, when the subscriber performs the insurance subscription procedure using his/her own information terminal 101 in the information processing system 100 according to the present disclosure, the first insurance premium is calculated on the basis of the first information acquired from the information terminal 101, the second insurance premium is calculated on the basis of the second information acquired through the information terminal 101 or the like of the subscriber while the subscriber is performing activities to be covered by the insurance during the coverage period of the insurance, and the total amount of the first insurance premium and the second insurance premium is determined as the insurance premium of the subscriber. The base insurance premium in the golf insurance is determined as a fixed amount at the time of subscribing to the insurance on the basis of description contents of a subscription application and the like. Furthermore, the personal insurance premium in the golf insurance includes a first insurance premium determined at the time of subscribing to the insurance on the basis of the description contents of the subscription application and the like, and a second insurance premium determined on the basis of states acquired during playing golf (a state of a golf course and an environment such as weather).

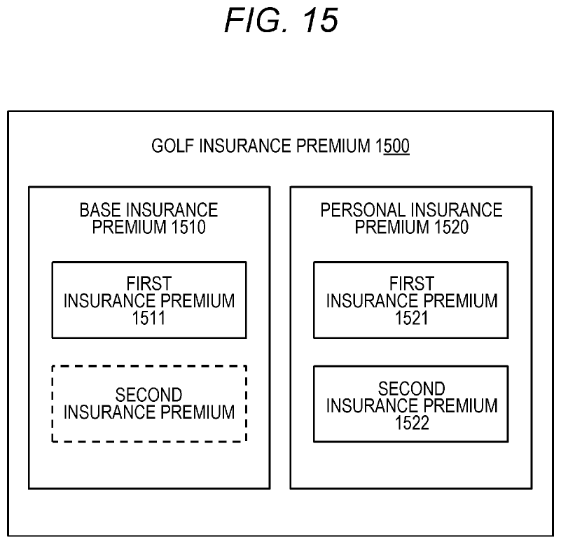

FIG. 15 schematically illustrates a configuration example of a golf insurance premium 1500. As described above, the golf insurance premium 1500 includes a base insurance premium 1510 and a personal insurance premium 1520.

A* first insurance premium 1511 of the base insurance premium 1510 is determined as a fixed amount by comprehensively assessing a general risk from information of a golf course to be played, information of a tool such as a club to be used by a subscriber, and information of members playing together. Furthermore, it is assumed that the base insurance premium 1510 does not vary after the fixed amount is determined at the time of subscribing to the insurance, that is, has no second insurance premium. Of course, the golf insurance according to the present disclosure can also be designed such that the base insurance premium 1510 includes a second insurance premium that varies on the basis of information sensed during play and the like.

On the other hand, a first insurance premium 1521 of the personal insurance premium 1520 is calculated from a general personal risk assessed on the basis of a health state, golf history, and a skill of a subscriber. The golf skill of the subscriber may be measured using, for example, a tool such as a swing analysis sensor. Furthermore, a second insurance premium 1522 of the personal insurance premium 1520 is calculated from a personal risk assessed on the basis of the subscriber's own health state sensed during play and an environment (weather and a state of a golf course).

### E-4. Examples of Use Cases

In this section, use cases in a case where the information processing system 100 according to the present disclosure is applied to a golf insurance service will be described separately for each of phases, that is, before play, during play on a golf course, and after play.

### E-4-1. Before Play

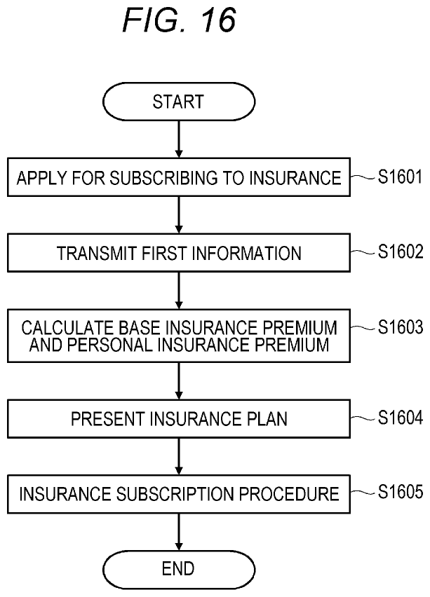

FIG. 16 illustrates a procedure performed by the information processing system 100 before play or at the time of subscribing to the golf insurance in a flowchart format.

First, a subscriber performs a procedure for subscribing to the golf insurance together with booking of a country club or the like (step S1601).

The subscriber transmits, to the information processing apparatus 102, information of golf tools such as clubs and shoes to be used by the subscriber, information of a reserved golf course, information of the subscriber's own golf history and skill level, information of members playing together, and the like in the golf insurance subscription procedure when performing a subscription application procedure through his/her information terminal 101 (step S1602). The golf skill of the subscriber may be measured using, for example, a tool such as a swing analysis sensor.

Then, the information processing apparatus 102 assesses a general risk on the basis of the information of the golf tools to be used by the subscriber, the information of the golf course, the information of the members playing together, a weather forecast of the country club at the scheduled date and time, and the like, and calculates the first insurance premium 1511 of the base insurance premium 1510. Furthermore, the information processing apparatus 102 assesses a personal risk of the subscriber him/herself on the basis of a health state of the subscriber, the golf history and the golf skill level of the subscriber, and the like, and calculates the first insurance premium 1521 of the personal insurance premium 1520 (step S1603).

Next, the information processing apparatus 102 transmits and presents information of a golf insurance plan including information of the base insurance premium and the personal insurance premium calculated in step S1603 to the information terminal 101 of the subscriber (step S1604).

The subscriber confirms contents of the proposed golf insurance plan on his/her information terminal 101 and performs the subscription procedure (step S1605). The presented golf insurance plan also includes the information of the base insurance premium and the personal insurance premium calculated on the basis of information before golf play. In a case of subscribing to the golf insurance according to the presented plan, the information processing apparatus 102 determines the base insurance premium, and determines, in a case where the subscriber selects an option of personal insurance, an insurance premium obtained by adding the base insurance premium and the personal insurance premium.

### E-4-2. During Play

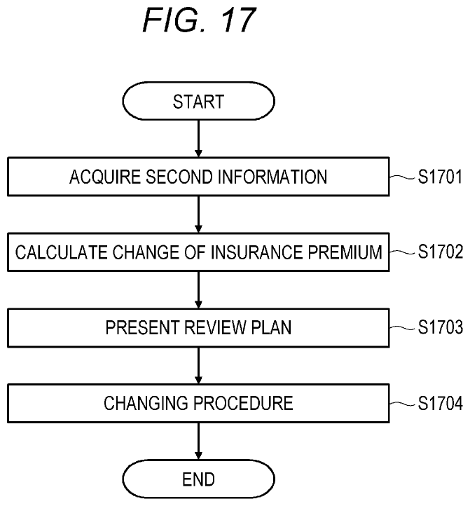

FIG. 17 illustrates a procedure performed by the information processing system 100 during play of the subscriber on a golf course in a flowchart format.

The information processing apparatus 102 acquires second information from the information terminal 101 of the subscriber and an IoT device (step S1701).

The second information includes information regarding an environment such as a health state of the subscriber, weather of a country club during play, and a state of the golf course detected by the sensor unit 470 in the information terminal 101 and the IoT device. The information processing apparatus 102 may acquire some of the second information, for example, the weather, the state of the golf course, or the like from a web site instead of the information terminal 101.

Then, the information processing apparatus 102 assesses a risk on the basis of the acquired second information, and calculates the second insurance premium 1522 of the personal insurance premium 1520 (step S1702). Note that the base insurance premium 1510 is designed not to include the second insurance premium (or the base insurance premium 1510 is the fixed amount) in the configuration example of the insurance premium illustrated in FIG. 15, but the second insurance premium of the base insurance premium is also calculated in step S1702 in a case where the base insurance premium 1510 is designed to include the second insurance premium.

Next, the information processing apparatus 102 transmits and presents information of a review plan of the subscribed golf insurance including information regarding an increased or decreased amount of the personal insurance premium on the basis of the second insurance premium 1522 calculated in step S1702 to the information terminal 101 of the subscriber (step S1703).

The subscriber confirms contents of the proposed review plan on his/her information terminal 101 and performs a procedure for changing the subscribed golf insurance (step S1704). The presented review plan also includes information regarding a changed amount relative to the personal insurance premium calculated on the basis of information before the subscription. In a case where the golf insurance is changed according to the presented review plan, the information processing apparatus 102 determines an insurance premium including the base insurance premium and the personal insurance premium only changed by the changed amount.

Note that the information processing apparatus 102 may perform the acquisition of the second information and the calculation of the second insurance premium, that is, the review of the golf insurance premium a plurality of times during a round. For example, the acquisition of the second information and the calculation of the second insurance premium may be performed every time the subscriber holes out or every predetermined number of holes.

### E-4-3. After Play

The information processing apparatus 102 charges a finally confirmed golf insurance premium when the subscriber ends a round. For example, the information processing apparatus transmits an e-mail to the information terminal 101 possessed by the subscriber to present the finally confirmed golf insurance premium. The subscriber may perform a golf insurance premium payment procedure directly on a screen on which his/her golf insurance premium has been presented.

### E-5. Functional Configuration

In this section, a functional configuration for calculating an insurance premium of the golf insurance in the information processing apparatus 102 will be described separately for the first insurance premium calculation before play and the second insurance premium calculation during a round.

### E-5-1. First Insurance Premium Calculation

The configuration of the golf insurance premium as illustrated in FIG. 15 is applied. The golf insurance premium 1500 includes the base insurance premium 1510 and the personal insurance premium 1520. Then, the base insurance premium 1510 includes a fixed amount of the first insurance premium 1511 determined at the time of subscribing to the insurance. Furthermore, the personal insurance premium 1520 is an insurance premium that is an individual option for each of subscribers, and includes a first insurance premium 521 determined before play and a second insurance premium 522 determined during a round.

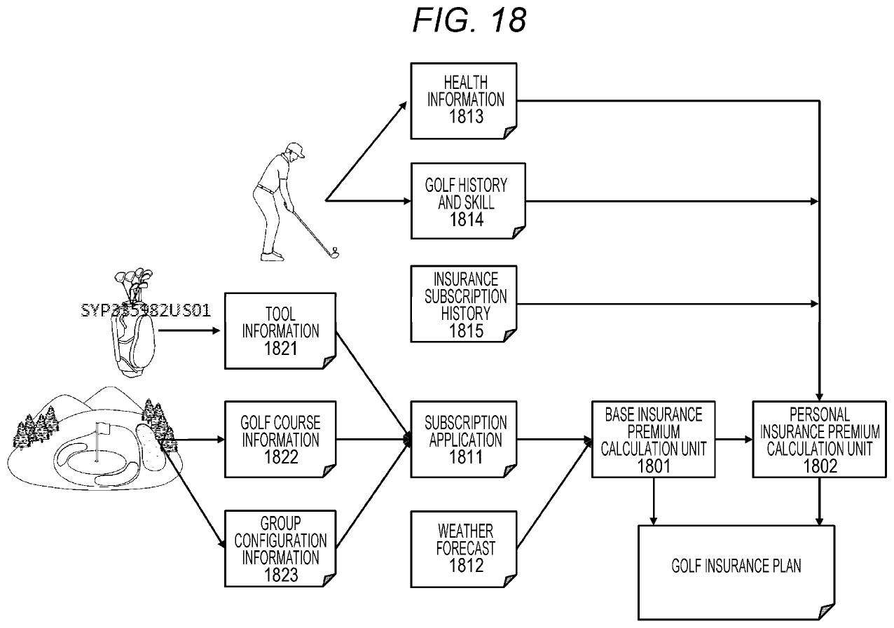

FIG. 18 illustrates a functional configuration example for the information processing apparatus 102 to calculate the first insurance premium of the golf insurance. The information processing apparatus 102 includes a base insurance premium calculation unit 1801 and a personal insurance premium calculation unit 1802 in order to calculate the first insurance premium of the golf insurance premium. The base insurance premium calculation unit 1801 calculates the first insurance premium 1511 of the base insurance premium 1510, and the personal insurance premium calculation unit 1802 calculates the first insurance premium 1521 of the personal insurance premium 1520. In the system configuration example illustrated in FIGS. 1 and 2, the base insurance premium calculation unit 1801 and the personal insurance premium calculation unit 1802 are arranged in the information processing apparatus 102. However, in a case where an insurance application executed on the information terminal 101 performs the golf insurance premium calculation processing, the base insurance premium calculation unit 1801 and the personal insurance premium calculation unit 1802 are respectively implemented as functional modules of the insurance application. A method of calculating the first insurance premiums 1511 and 1512 will be described in detail with reference to FIG. 18.

The subscriber compiles tool information 1821, golf course information 1822, and group configuration information 1823 to create a golf insurance subscription application 1811. The tool information 1821 includes information of clubs, golf shoes, balls, and the like to be used in the round of golf covered by the golf insurance. The golf course information 1822 includes information regarding features of golf courses including a difficulty level and a course shape (a right dogleg or a left dogleg, many or few short courses, many or few long courses, and the like) of each of the golf courses to be rounded on the country club where play is scheduled. The group configuration information 1823 includes personal information such as gender and age of each of members playing together. The subscriber creates an application for subscription to the golf insurance on his/her information terminal 101 and transmits the application to the information processing apparatus 102.

In addition to the tool information 1821, the golf course information 1822, and the group configuration information 1823 described in the subscription application 1811, the base insurance premium calculation unit 1801 collects a weather forecast 1812 on the day of play of the country club where the play is scheduled as first information. The weather forecast 1812 may be acquired from a web site. A risk varies depending on performance of the clubs to be used, the difficulty level of the golf course, the members playing together, and the like, and the base insurance premium calculation unit 1801 assesses a general risk from these pieces of the first information. Then, the base insurance premium calculation unit 1801 calculates a fixed amount of the base insurance premium 1511 on the basis of the assessed risk.

The personal insurance premium calculation unit 1802 calculates the first insurance premium 1521 of the personal insurance premium 1520 on the basis of first information unique to each subscriber including health information 1813 of the subscriber, golf history and skill 1814, and an insurance subscription history 1815. A golf skill level of the subscriber included in the golf history and skill 1814 may be self-reported by the subscriber, or may be an analysis result obtained by a swing analysis sensor. Insurance subscription history information and other personal information of the subscriber having a subscription history are accumulated in the storage apparatus 320.

Then, the information processing apparatus 102 transmits a golf insurance plan including the information of the first insurance premium 1521 of the fixed amount of the base insurance premium 1510 calculated by the base insurance premium calculation unit 1801 and the personal insurance premium 1520 calculated by the personal insurance premium calculation unit 1802 to the information terminal 101 of the subscriber and presents the golf insurance plan to the subscriber before play.

### E-5-2. Second Insurance Premium Calculation

As illustrated in FIG. 15, a second insurance premium of the golf insurance 1500 includes the second insurance premium 1522 of the personal insurance premium 1520. The second insurance premium 1522 of the personal insurance premium 1520 is a change of the first insurance premium 1521 of the personal insurance premium 1520 calculated before play, the change occurring during play. Of course, it is also possible to design the golf insurance such that the base insurance premium 1510 also includes the second insurance premium, but the description will be given here assuming that the base insurance premium 1510 does not the second insurance premium.

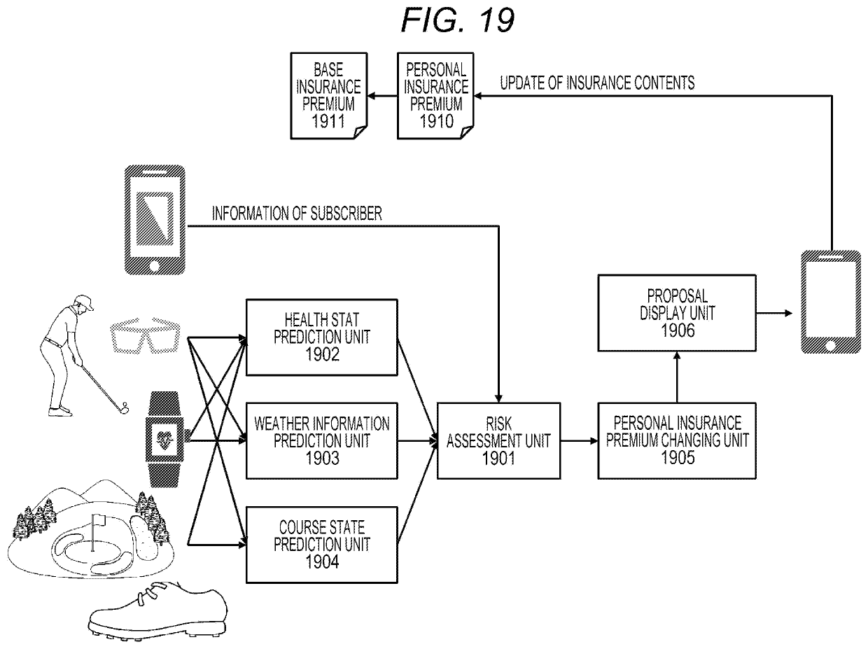

FIG. 19 illustrates a functional configuration example for the information processing apparatus 102 to calculate the second insurance premium of the golf insurance. The information processing apparatus 102 includes a risk assessment unit 1901 and a personal insurance premium changing unit 1905 in order to calculate the second insurance premium out of the golf insurance premium.

The risk assessment unit 1901 assesses a risk of subscriber's own injuries and personal injury and property damage on the basis of a health state of the subscriber during golf play, weather of a golf course where play is being performed, and a course state of the golf course. The risk assessment unit 1901 may assess the risk of the subscriber during golf play using a deep-learned learning model.

Furthermore, the information processing apparatus 102 includes a health state prediction unit 1902 that predicts the health state of the subscriber, a weather information prediction unit 1903 that predicts weather of a country club, and a course state prediction unit 1904 that predicts a state of the golf course in order to predict the health state of the subscriber during play, the weather of the country club during play, and the state of the golf course during play, which are necessary for the risk assessment, on the basis of sensor information from the information terminal 101 possessed by the subscriber and an IoT device.

The personal insurance premium changing unit 1905 calculates the second insurance premium 1522 that is a change, which has occurred due to a risk variation during play, of the first insurance premium 1521 of the personal insurance premium 1520 calculated at the time of subscribing to the insurance or before play on the basis of the assessment result of a personal risk obtained by the risk assessment unit 1901. The personal insurance premium changing unit 1905 may calculate the second insurance premium 1522 using a deep-learned learning model.

Then, the information processing apparatus 102 includes a proposal presentation unit 1906 that proposes a review plan of the golf insurance to the subscriber on the basis of the second insurance premium 1522 of the personal insurance premium 1520 calculated by the personal insurance premium changing unit 1905. The proposal presentation unit 1906 notifies the information terminal 101 of the subscriber of the review plan of the golf insurance by e-mail transmission or the like, for example.

The subscriber considers the proposed review plan and requests the information processing apparatus 102 to update insurance contents from his/her information terminal 101. The information processing apparatus 102 side updates a personal insurance premium 1910 of the subscriber and updates a base insurance premium 1911 in response to the request for updating the insurance contents from the information terminal 101.

Note that at least some of the functional modules 1901 to 1906 illustrated in FIG. 19 may be arranged not on the information processing apparatus 102 but on the information terminal 101 possessed by the subscriber. For example, at least some functions of the functional modules 1901 to 1906 may be implemented as operations of an insurance application started on the information terminal 101.

Next, each of the prediction units 1902 to 1904 configured to assess the risk during play will be described.

Each of the prediction units 1902 to 1904 performs prediction on the basis of sensor information from the sensor unit 470 in the information terminal 101 and IoT devices and information acquired from a web site. The IoT devices include a smart watch, a smart glass or goggle, a shoe sensor, a swing analysis sensor, a score and course detection sensor, and the like. Regarding the sensor information measured by each of the IoT devices, Section D-2 described above may referred to. Basically, each of the prediction units 1005 to 1007 uses the sensor information from the sensor unit 470 in the information terminal 101 and the IoT device, and the information acquired from the web site as explanatory variables, and performs processing of calculating a desired objective variable from the explanatory variables on the basis of each of prediction models.

The health state prediction unit 1902 predicts the health state of the subscriber on the basis of the sensor information from the sensor unit 470 in the information terminal 101 and the IoT device. The health state prediction unit 1902 calculates an objective variable using a prediction model on the basis of logistic regression from explanatory variables including health information, activity information, and weather information, with the health state represented by a value of 0.0 to 1.0, for example, as the objective variable. Among the explanatory variables, the health information includes a body temperature, a heart rate or a pulse wave, an electrocardiogram, a blood oxygen concentration, and sleeping hours. Among the explanatory variables, the activity information includes a movement distance, movement altitude or a difference of altitude, and a total number of steps. Furthermore, among the explanatory variables, the weather information includes temperature, humidity, wind speed, rainfall, an amount of ultraviolet light, and daily illuminance. The prediction model based on the logistic regression predicts the health state by the prediction model generated by learning on, for example, a cloud using data collected from a large number of insurance subscribers.

The weather information prediction unit 1903 measures a current weather of a climbing course on the basis of the sensor information from the sensor unit 470 in the information terminal 101 and the IoT device. Furthermore, the weather information prediction unit 1903 predicts the weather of remaining holes from a weather forecast acquired by accessing a weather forecast site on the Web.

The course state prediction unit 1904 predicts a state of each of golf courses where the subscriber performs play on the basis of the sensor information from the sensor unit 470 in the information terminal 101 and the IoT device. The course state prediction unit 1904 calculates objective variables from explanatory variables including an image of a golf course, an image of weather information, and an amount of moisture using a prediction model based on a decision tree such as random forest or MLP, with a type of the golf course and the state of the course as the objective variables. The course type as the objective variable includes, for example, a course difficulty level and a course shape (a right dogleg or a left dogleg, many or few short courses, many or few long courses, and the like). Furthermore, the course states of the respective course types are represented by grass states of rough or green and bunker states (an amount of water, sand quality, and the like). Among the explanatory variables, the image of the golf course is, for example, an image of the golf course captured by a smart glass, the image of the weather information is an image of the sky captured by the smart glass, and the amount of water is an amount of water measured by a water amount sensor installed at the bottom of a golf shoe. The prediction model based on the random forest or the MLP classifies the state of the golf course by executing a prediction model generated by learning on, for example, a cloud using data collected from a large number of insurance subscribers. The prediction model predicts the state of the golf course every time the course type changes.

### E-6. Specific Examples of Risk Assessment and Insurance Premium Calculation

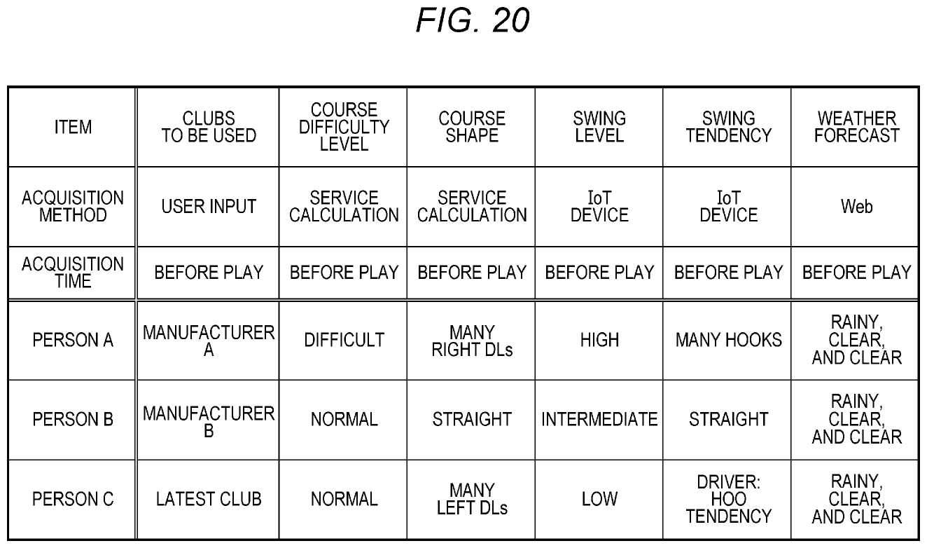

FIG. 20 illustrates types of first information acquired by the information processing system 100 to calculate a first insurance premium of the golf insurance before golf play (for example, when subscribers subscribe to the golf insurance), an acquisition method of each piece of the information, and input examples of the respective subscribers A to C.

A club to be used can be obtained, for example, from the tool information 1821 described in the subscription application 1811. A course difficulty level and a course shape can be acquired from a country club or other web sites on the basis of, for example, the golf course information 1822 (a name of the country club and the like) described in the subscription application 1811. Furthermore, a swing level and a swing tendency can be acquired from user inputs such as self-report of the subscriber described in the subscription application 1811, or can be acquired from sensor information from a swing analysis sensor. Furthermore, as a weather forecast, weather information at a play date and time of the country club can be acquired on the basis of the play date and time described in the subscription application 1811 by web access to a weather forecast site or the like.

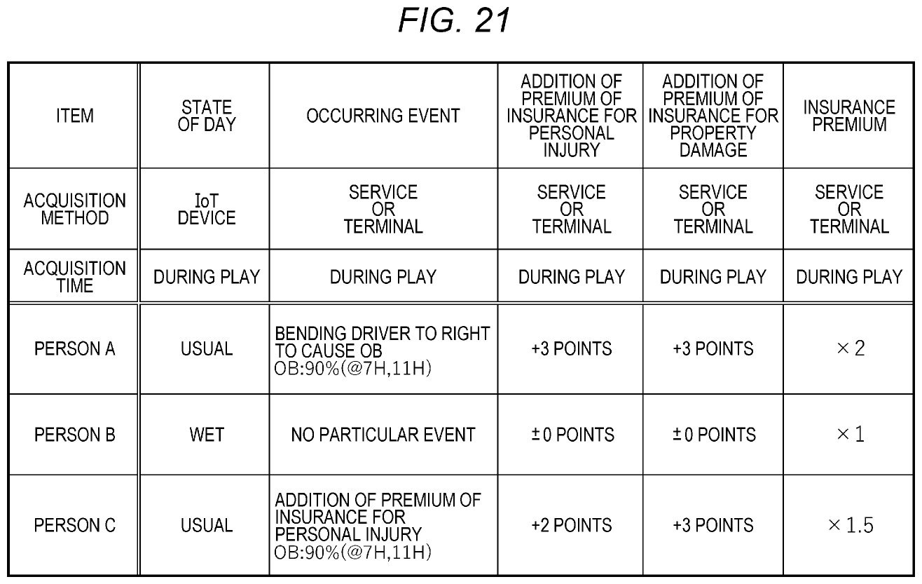

FIG. 21 illustrates types of second information acquired by the information processing system 100 to calculate a second insurance premium during golf play (or during a coverage period of the subscribed golf insurance), an acquisition method of each piece of the information, and an input example of each of members A to C playing together. Furthermore, FIG. 21 also illustrates a changed insurance premium based on a risk of each of the members assessed on the basis of the input example of the second information of each of the members A to C.

During play on a country club, a state of the day including a plurality of factors such as health information, weather information, and a course state can be acquired as the second information of each of the members from a smart glass, a smart watch, a shoe sensor, or other IoT devices. In FIG. 21, the plurality of factors is collectively indicated by abstracted expressions such as “usual” and “wet” in order to simplify the drawing.

Then, the information processing system 100 assesses a risk of occurrence of an event that can be covered by the insurance for each of the members on the basis of the first information acquired before play as illustrated in FIG. 20 and the second information acquired during play as illustrated in FIG. 21. The example illustrated in FIG. 21 indicates that the information processing system 100 assesses that both Person A and Person C have a risk of “bending a driver to right to cause OB in Hole 7 and Hole 11” of 90%.

Then, in the information processing system 100, the personal insurance premium changing unit 1905 calculates a change of a golf insurance premium on the basis of a risk assessment result of each of the members. In the example illustrated in FIG. 21, the change of the insurance premium depending on the risk is calculated separately for insurance for personal injury and insurance for property damage, and a calculation result is indicated on a scale of 10 points.

Since the risk of bending the driver to the right to cause OB in Hole 7 and Hole 11 is 90% for Person A, 3 points are added for both the insurance for personal injury and the insurance for property damage. As a result, a final insurance premium of Person A is twice an insurance premium calculated at the time of subscription. Furthermore, since the risk of bending the driver to the right to cause OB in Hole 7 and Hole 11 is 90% for Person C, 2 points are added for the insurance for personal injury, and 3 points are added for the insurance for property damage. As a result, a final insurance premium of Person C is 1.5 times an insurance premium calculated at the time of subscription. Furthermore, it has been assessed that Person B has no particular risk of occurrence of an event that may be covered by the insurance, there is no change for both the insurance for personal injury and the insurance for property damage, and a final insurance premium is still an amount calculated at the time of subscription.

### INDUSTRIAL APPLICABILITY

The present disclosure has been described in detail above with reference to specific embodiments. However, it is self-evident that those skilled in the art can make alterations and substitutions of the embodiments within a scope not departing from a gist of the present disclosure.

The present disclosure can be applied to the operation of a small-amount and short-term insurance service mainly intended for a specific sport or hobby, but of course, can also be applied to various other types of online insurance services.

In short, the present disclosure has been described in the form of exemplification, and the contents described in the present specification should not be interpreted in a limited manner. In order to determine the gist of the present disclosure, the scope of claims should be taken into consideration.

Note that the present disclosure can have the following configurations.

(1) An information processing system including:
an information acquisition unit that acquires first information when a subscriber subscribes to insurance and acquires second information within a coverage period of the insurance;
an insurance premium determination unit that calculates a first insurance premium on the basis of the first information, calculates a second insurance premium on the basis of the second information, and determines an insurance premium of the subscriber on the basis of the first insurance premium and the second insurance premium; and
a presentation unit that presents information regarding the insurance premium to an information terminal of the subscriber.

(2) The information processing system according to (1) described above, further including:
the information terminal with which the subscriber performs an insurance subscription procedure; and
an information processing apparatus that calculates an insurance premium of the insurance of the subscriber,
in which the information terminal, as the information acquisition unit, acquires the first information when the subscriber subscribes to the insurance, acquires the second information within the coverage period of the insurance, and transmits the first information and the second information to the information processing apparatus, and
the information processing apparatus calculates the first insurance premium on the basis of the first information, calculates the second insurance premium on the basis of the second information, and determines a sum of the first insurance premium and the second insurance premium as the insurance premium of the subscriber together with the insurance premium determination unit.

(3) The information processing system according to (1) described above, in which
the information terminal
serves as the information acquisition unit to acquire the first information when the subscriber subscribes to the insurance and acquire the second information within the coverage period of the insurance, and
calculates the first insurance premium on the basis of the first information, calculates the second insurance premium on the basis of the second information, determines the insurance premium of the subscriber on the basis of the first insurance premium and the second insurance premium, and presents the determined insurance premium to the subscriber together with the insurance premium determination unit.

(4) The information processing system according to any one of (1) to (3) described above, in which
the first information and the second information include at least one of information input to the information terminal by the subscriber or sensor information from a sensor in the information terminal or an IoT device around the information terminal.

(5) The information processing system according to any one of (1) to (4) described above, in which
the first information includes subscriber information for identifying the subscriber, and information regarding an insurance type selected by the subscriber, a compensation amount, or other insurance conditions,
the second information includes information when the subscriber performs an activity covered by the insurance within the coverage period of the insurance, and
the first insurance premium is calculated under the selected insurance type and the insurance conditions on the basis of the first information, and the second insurance premium is calculated on the basis of the second information.

(6) The information processing system according to any one of (1) to (5) described above, in which
the activity covered by the insurance is climbing, and the coverage period is a day on which the subscriber performs the climbing.

(7) The information processing system according to (6) described above, in which
the information acquisition unit acquires the first information including at least one of information regarding a mountain to be climbed, information regarding a climbing plan such as a climbing style, a climbing date, the number of accommodation days, and a climbing purpose, or information of each of members of a climbing party, and
the insurance premium determination unit determines a uniform base insurance premium for all the members of the climbing party on the basis of the first information.

(8) The information processing system according to (7) described above, in which
the information acquisition unit acquires the first information including health states of the respective members, and
the insurance premium determination unit further determines a personal insurance premium to be added for each of the members on the basis of the first information.

(9) The information processing system according to (8) described above, in which
the information acquisition unit acquires the second information including at least one of health states of the respective members during the climbing, weather of the mountain during the climbing, or a state of a climbing course during the climbing, and
the insurance premium determination unit determines a changed amount of the base insurance premium and a changed amount of the personal insurance premium on the basis of the second information.

(10) The information processing system according to any one of (1) to (5) described above, in which
the activity covered by the insurance is golf, and the coverage period is a day on which the subscriber plays the golf.

(11) The information processing system according to (10) described above, in which
the information acquisition unit acquires the first information including at least one of information of a tool to be used by the subscriber, golf course information, or information of a member playing together, and
the insurance premium determination unit determines the first insurance premium on a basis of a risk assessed from the first information.

(12) The information processing system according to (11) described above, in which
the acquisition unit acquires the second information including at least one of a health state of the subscriber, weather of a golf course, or a state of the golf course during golf play, and
the insurance premium determination unit determines the second insurance premium on the basis of a risk assessed from the second information.

(13) An information processing method including:
an information acquisition step of acquiring first information when a subscriber subscribes to insurance and acquiring second information within a coverage period of the insurance;
an insurance premium determination step of calculating a first insurance premium on the basis of the first information, calculating a second insurance premium on the basis of the second information, and determining an insurance premium of the subscriber on the basis of the first insurance premium and the second insurance premium; and
a presentation step of presenting information regarding the insurance premium to an information terminal of the subscriber.

(14) An information terminal including:
an information acquisition unit that acquires first information when a subscriber subscribes to insurance and acquires second information within a coverage period of the insurance; and
a presentation unit that presents information regarding an insurance premium of the subscriber determined on the basis of a first insurance premium calculated on the basis of the first information and a second insurance premium calculated on the basis of the second information.

(15) The information terminal according to (14) described above, in which
the information acquisition unit transmits the acquired first information and second information to an information processing apparatus, and
the presentation unit presents the information regarding the insurance premium determined on the basis of the first information and the second information by the information processing apparatus.

(16) The information terminal according to (14) described above, further including
an insurance premium determination unit that calculates the first insurance premium on the basis of the first information, calculates the second insurance premium on the basis of the second information, and determines the insurance premium of the subscriber on the basis of the first insurance premium and the second insurance premium.

(17) An information processing apparatus including:
a reception unit that receives, from an information terminal of a subscriber, first information acquired when the subscriber subscribes to insurance and second information acquired within a coverage period of the insurance;
an insurance premium determination unit that calculates a first insurance premium on the basis of the first information, calculates a second insurance premium on the basis of the second information, and determines an insurance premium of the subscriber on the basis of the first insurance premium and the second insurance premium; and
a presentation unit that presents information regarding the insurance premium to an information terminal of the subscriber.

(18) A computer program described in a computer-readable format to cause a computer to function as:
an information acquisition unit that acquires first information when a subscriber subscribes to insurance and acquires second information within a coverage period of the insurance;
an insurance premium determination unit that calculates a first insurance premium on the basis of the first information, calculates a second insurance premium on the basis of the second information, and determines an insurance premium of the subscriber on the basis of the first insurance premium and the second insurance premium; and
a presentation unit that presents information regarding the insurance premium to an information terminal of the subscriber.

### REFERENCE SIGNS LIST

100 Information processing system
101 Information terminal
102 Information processing apparatus
104 Internet
301 CPU
301A, 301B Processor core
310 Bus
320 Storage apparatus
321 Memory
330 Input/output interface unit
410 Control unit
411 CPU
412 ROM
413 RAM
420 Display unit
421 Display panel
422 Display interface
423 Touch panel
424 Touch interface
430 Speech processing unit
431 Speech output unit
432 Speech input unit
434 Speech codec
434 Speech output terminal
440 Communication unit
441 LTE communication unit
442 Wi-Fi (registered trademark) communication unit
443 BLE communication unit
450 Storage unit
460 Imaging unit
470 Sensor unit
901 Base insurance premium calculation unit
902 Personal insurance premium calculation unit
1001 Group risk assessment unit
1002 Base insurance premium changing unit
1003 Personal risk assessment unit
1004 Personal insurance premium changing unit
1005 Health state prediction unit
1006 Weather information prediction unit
1007 Course state prediction unit
1008 Proposal presentation unit
1009 Information sharing unit
1801 Base insurance premium calculation unit
1802 Personal insurance premium calculation unit
1901 Risk assessment unit
1902 Health state prediction unit
1903 Weather information prediction unit
1904 Course state prediction unit
1905 Personal insurance premium changing unit
1906 Proposal display unit

1. An information processing system comprising:
an information acquisition unit that acquires first information when a subscriber subscribes to insurance and acquires second information within a coverage period of the insurance;
an insurance premium determination unit that calculates a first insurance premium on a basis of the first information, calculates a second insurance premium on a basis of the second information, and determines an insurance premium of the subscriber on a basis of the first insurance premium and the second insurance premium; and
a presentation unit that presents information regarding the insurance premium to an information terminal of the subscriber.

2. The information processing system according to claim 1, further comprising:
the information terminal with which the subscriber performs an insurance subscription procedure; and
an information processing apparatus that calculates an insurance premium of the insurance of the subscriber,
wherein the information terminal, as the information acquisition unit, acquires the first information when the subscriber subscribes to the insurance, acquires the second information within the coverage period of the insurance, and transmits the first information and the second information to the information processing apparatus, and
the information processing apparatus calculates the first insurance premium on a basis of the first information, calculates the second insurance premium on a basis of the second information, and determines a sum of the first insurance premium and the second insurance premium as the insurance premium of the subscriber together with the insurance premium determination unit.

3. The information processing system according to claim 1, wherein
the information terminal
serves as the information acquisition unit to acquire the first information when the subscriber subscribes to the insurance and acquire the second information within the coverage period of the insurance, and
calculates the first insurance premium on a basis of the first information, calculates the second insurance premium on a basis of the second information, determines the insurance premium of the subscriber on a basis of the first insurance premium and the second insurance premium, and presents the determined insurance premium to the subscriber together with the insurance premium determination unit.

4. The information processing system according to claim 1, wherein
the first information and the second information include at least one of information input to the information terminal by the subscriber or sensor information from a sensor in the information terminal or an IoT device around the information terminal.

5. The information processing system according to claim 1, wherein
the first information includes subscriber information for identifying the subscriber, and information regarding an insurance type selected by the subscriber, a compensation amount, or other insurance conditions,
the second information includes information when the subscriber performs an activity covered by the insurance within the coverage period of the insurance, and
the insurance premium determination unit calculates the first insurance premium under the selected insurance type and the insurance conditions on a basis of the first information, and calculates the second insurance premium on a basis of the second information.

6. The information processing system according to claim 1, wherein
the activity covered by the insurance is climbing, and the coverage period is a day on which the subscriber performs the climbing.

7. The information processing system according to claim 6, wherein
the information acquisition unit acquires the first information including at least one of information regarding a mountain to be climbed, information regarding a climbing plan such as a climbing style, a climbing date, a number of accommodation days, and a climbing purpose, or information of each of members of a climbing party, and
the insurance premium determination unit determines a uniform base insurance premium for all the members of the climbing party on a basis of the first information.

8. The information processing system according to claim 7, wherein
the information acquisition unit acquires the first information including health states of the respective members, and
the insurance premium determination unit further determines a personal insurance premium to be added for each of the members on a basis of the first information.

9. The information processing system according to claim 8, wherein
the information acquisition unit acquires the second information including at least one of health states of the respective members during the climbing, weather of the mountain during the climbing, or a state of a climbing course during the climbing, and
the insurance premium determination unit determines a changed amount of the base insurance premium and a changed amount of the personal insurance premium on a basis of the second information.

10. The information processing system according to claim 1, wherein
the activity covered by the insurance is golf, and the coverage period is a day on which the subscriber plays the golf.

11. The information processing system according to claim 10, wherein
the information acquisition unit acquires the first information including at least one of information of a tool to be used by the subscriber, golf course information, or information of a member playing together, and
the insurance premium determination unit determines the first insurance premium on a basis of a risk assessed from the first information.

12. The information processing system according to claim 11, wherein
the acquisition unit acquires the second information including at least one of a health state of the subscriber, weather of a golf course, or a state of the golf course during golf play, and
the insurance premium determination unit determines the second insurance premium on a basis of a risk assessed from the second information.

13. An information processing method comprising:
an information acquisition step of acquiring first information when a subscriber subscribes to insurance and acquiring second information within a coverage period of the insurance;
an insurance premium determination step of calculating a first insurance premium on a basis of the first information, calculating a second insurance premium on a basis of the second information, and determining an insurance premium of the subscriber on a basis of the first insurance premium and the second insurance premium; and
a presentation step of presenting information regarding the insurance premium to an information terminal of the subscriber.

14. An information terminal comprising:
an information acquisition unit that acquires first information when a subscriber subscribes to insurance and acquires second information within a coverage period of the insurance; and
a presentation unit that presents information regarding an insurance premium of the subscriber determined on a basis of a first insurance premium calculated on a basis of the first information and a second insurance premium calculated on a basis of the second information.

15. The information terminal according to claim 14, wherein
the information acquisition unit transmits the acquired first information and second information to an information processing apparatus, and
the presentation unit presents the information regarding the insurance premium determined on a basis of the first information and the second information by the information processing apparatus.

16. The information terminal according to claim 14, further comprising
an insurance premium determination unit that calculates the first insurance premium on a basis of the first information, calculates the second insurance premium on a basis of the second information, and determines the insurance premium of the subscriber on a basis of the first insurance premium and the second insurance premium.

17. An information processing apparatus comprising:
a reception unit that receives, from an information terminal of a subscriber, first information acquired when the subscriber subscribes to insurance and second information acquired within a coverage period of the insurance;
an insurance premium determination unit that calculates a first insurance premium on a basis of the first information, calculates a second insurance premium on a basis of the second information, and determines an insurance premium of the subscriber on a basis of the first insurance premium and the second insurance premium; and
a presentation unit that presents information regarding the insurance premium to an information terminal of the subscriber.

18. A computer program described in a computer-readable format to cause a computer to function as:
an information acquisition unit that acquires first information when a subscriber subscribes to insurance and acquires second information within a coverage period of the insurance;
an insurance premium determination unit that calculates a first insurance premium on a basis of the first information, calculates a second insurance premium on a basis of the second information, and determines an insurance premium of the subscriber on a basis of the first insurance premium and the second insurance premium; and
a presentation unit that presents information regarding the insurance premium to an information terminal of the subscriber.
